(19) United States
(12) Patent Application Publication
(10) Pub. No.: US 2024/0089310 A1
(43) Pub. Date: Mar. 14, 2024

(54) PACKET WASH FOR INTERLACED IMAGES

(71) Applicant: HUAWEI TECHNOLOGIES CO., LTD., Shenzhen (CN)

(72) Inventors: Lijun Dong, Santa Clara, CA (US); Kiran Makhijani, Santa Clara, CA (US)

(21) Appl. No.: 18/513,270

(22) Filed: Nov. 17, 2023

Related U.S. Application Data
(63) Continuation of application No. PCT/US2021/033415, filed on May 20, 2021.

(51) Int. Cl. H04L 65/752; H04N 21/2343

(52) U.S. Cl. CPC H04L 65/752; H04N 21/2343

(57) ABSTRACT

An image coding mechanism is disclosed. The mechanism includes designating a plurality of chunks of an interlaced image file as critical or ancillary. The chunks are positioned in a packet in a distinct order according to a priority of the chunks and their designation as critical or ancillary. The packet is transmitted toward an image destination.

### CROSS-REFERENCE TO RELATED APPLICATIONS

This application is a continuation of International Application No. PCT/US2021/033415 filed on May 20, 2021, by Futurewei Technologies, Inc., and titled “Packet Wash for Interlaced Image” which is hereby incorporated by reference.

### TECHNICAL FIELD

The present disclosure is generally related to media data coding, and is specifically related to mechanisms for coding interlaced image data, such as images coded as Portable Network Graphics (PNG) files, to allow a transmission network to dynamically reduce the quality and/or functionality of the image data in order to support transmission in the presence of network congestion.

### BACKGROUND

Interlacing is a mechanism of coding an image so that a receiver that receives only part of the image can display a degraded copy of the image. Interlacing is also known as interleaving. For example, interlacing can include creating a plurality of reduced versions of an image. The reduced images can be transmitted separately and combined by the receiver to recreate a copy of the original image. Any reduced image that is not received can be left out, which has a corresponding degradation effect on the copy of the image created at the receiver. As used herein, interlacing may include similar concepts, such as progressive scan. Regardless of the specific embodiment, interlaced images are coded at a specified quality at an encoder. Interlaced images are designed to function in the event that components of the image are lost and/or delayed by the network. However, interlaced images are not designed to indicate to the network the relative importance of any particular component of the image. As such, each component has roughly the same chance of becoming lost and/or delayed. Further, most networks employ best efforts to ensure that all components of the image arrive at their destination.

### SUMMARY

In an embodiment, the disclosure includes a method implemented by an image source, the method comprising: designating, by one of more processors of the source, each chunk of a plurality of chunks of an interlaced image file as critical or ancillary; positioning, by the processors, the chunks in a packet in a priority order according to a priority of the chunks and their designation as critical or ancillary; and transmitting, by a transmitter of the source, the packet toward an image destination.

Network qualitative communication is a network paradigm configured to mitigate data loss in a network due to network congestion. In a network configured for network qualitative communication, network nodes are configured to perform a packet wash operation. A packet wash is performed when a packet would otherwise be dropped due to network congestion. Instead of dropping the entire packet, the packet wash removes portions of the packet, which can be called chunks. This has the effect of reducing the size of the packet until that packet is small enough to be handled by the network in spite of the congestion (or similarly, a group of packets are small enough to be handled). The chunks of the packets can be arranged in order of priority so that the most important information is preserved while the least important information is discarded during the packet wash operation. As a result, the most important information in a packet may still be successfully transmitted through the network instead of being dropped. Such a packet wash operation is not designed to operate on interlaced images, such as images coded according to PNG. Specifically, a PNG file can separate an image into seven reduced images. Each image can be sent in a separate stream of packet(s). Further, metadata describing the image can be attached to one or more of the relevant streams. However, none of the data is arranged based on a priority. Accordingly, a packet wash operation may not be directly applied to a PNG data packet as the packet wash may be unable to determine which data can be discarded and which data should be maintained. Further, in some cases users may be willing to accept the loss of the functionality associated with certain portions of the metadata and/or may be willing to accept the loss image quality associated with the loss of certain layers when such loss will speed up image transmission. However, PNG and related interlacing mechanisms are not natively designed to prioritize data to allow for such a loss.

The present example includes a mechanism to arrange interlaced image data according to a priority so that a packet wash may be applied to corresponding packets. For example, a PNG file employs seven layers of image data as well as various types of metadata. Such data is stored in chunks. The disclosed mechanism designates each chunk as either critical or ancillary. Critical chunks are positioned at the head of a corresponding packet and ancillary chunks are positioned toward the tail of the corresponding packet. A packet wash can then remove the ancillary chunks as desired to overcome network congestion. PNG standards generally place an image trailer (IEND) chunk as the last chunk in a packet. Accordingly, the present mechanism places the LEND chunk as the last critical chunk in the packet and ensures all other critical chunks are positioned before the LEND chunk. As such, such a node may assume every chunk after the LEND chunk is ancillary and can be removed by a packet wash to overcome congestion. In another example, the packet source (e.g., encoder/content server) can designate chunks as critical or ancillary based on parameters in an image file request from the destination (e.g., decoder).

In another example, one or more of the layers containing the reduced images can be designated as ancillary. In such a case, the IDAT chunks containing critical layers are designated as critical and IDAT chunks containing non-critical layers can be designated as ancillary. In one example, each of the seven layers of the image file can be transmitted in packets in separate data streams. The packet wash can then be applied to each packet as desired. For example, when a packet is part of a data stream containing a non-critical layer, the packet wash can remove the metadata related to ancillary chunks from the packet first and then the IDAT chunks in the packet as desired to overcome congestion. In another example, the entire image file can be included in a jumbo packet, for example according to a New internet protocol (IP) paradigm. Further, layers may each be assigned a priority level (e.g., a numeric value), where all priority values equal to or above a designated level are critical and all priority values below the designated level are ancillary. In such a case, the packet can be arranged with critical chunks including chunks of critical layers prior to the LEND chunk. The non-critical layers can be positioned after the LEND chunk in order of priority, and the metadata related ancillary chunks can be positioned at the end of the packet. In this way, a packet wash prioritizes dropping metadata first and then dropping image quality from lower to higher priority. In each of these examples, the receiver may receive a packet with ancillary chunks positioned after the LEND chunk, for example when packet washing is not needed and/or when not all of the ancillary chunks are dropped. In such a case, the receiver can reorder the data to place the LEND chunk as the last chunk in order before decoding the image data. In this way, the file is rearranged to comply with PNG standards before being sent to the decoder. The preceding examples allow a requestor to receive a requested image at a lower quality and/or with reduced functionality in case of network congestion instead of receiving nothing due to complete packet drop(s). This mechanism may provide a better user experience. Further, this mechanism may allow packet chunk drops to be prioritized based on a user request. Accordingly, the disclosed mechanisms may also reduce the incidence of re-requests for the image by the user, and hence reduce network traffic and corresponding network congestion. As such, the present mechanisms create additional functionality and reduce processor, memory, and/or network resource usage by an encoder, a content server, a source, a decoder, a destination, and/or an intermediate network node in a communication network.

Optionally, in any of the preceding aspects, another implementation of the aspect provides, wherein positioning the chunks comprises positioning critical chunks at a head of the packet, positioning an image trailer (TEND) chunk as a last chunk of the critical chunks, and positioning ancillary chunks at a tail of the packet after the LEND chunk.

Optionally, in any of the preceding aspects, another implementation of the aspect provides, wherein positioning the chunks comprises positioning all critical chunks of a layer before all ancillary chunks of the layer.

Optionally, in any of the preceding aspects, another implementation of the aspect provides, wherein positioning the chunks comprises positioning a critical chunk of a lower priority layer before an ancillary chunk of a higher priority layer.

Optionally, in any of the preceding aspects, another implementation of the aspect provides, wherein the critical chunks include an image header (IHDR) chunk, a palette table (PLTE) chunk, image data (IDAT) chunks, an LEND chunk, or combinations thereof.

Optionally, in any of the preceding aspects, another implementation of the aspect provides, wherein the ancillary chunks include a transparency information (tRNS) chunk, a chromaticity (cHRM) chunk, a gamma value (gAMA) chunk, an international color consortium (iCCP) chunk, a significant bits (sBIT) chunk, a standard red green blue (sRGB) chunk, a text keywork (iTXt) chunk, a text (tEXt) chunk, a compressed text (zTXt) chunk, a default background (bKGD) chunk, a histogram (hIST) chunk, an intended pixel size (pHYs) chunk, a suggested palette (sPLT) chunk, a time changed (tIME) chunk, or combinations thereof.

Optionally, in any of the preceding aspects, another implementation of the aspect provides, further comprising receiving, by a receiver of the source, a request for the interlaced image file containing parameters, and wherein positioning the chunks in the packet in a priority order of the priority is based on the parameters in the request.

Optionally, in any of the preceding aspects, another implementation of the aspect provides, wherein the parameters in the request indicate one or more of an image smoothness requirement of an image destination, an image attribute preference of the image destination, or a decoding capability of the image destination.

Optionally, in any of the preceding aspects, another implementation of the aspect provides, wherein the chunks are positioned to support removal of the ancillary chunks by a packet wash process during packet transit.

Optionally, in any of the preceding aspects, another implementation of the aspect provides, wherein the image data chunks are associated with seven layers of the interlaced image file, and wherein each layer of the interlaced image file is positioned into a different stream of packets.

Optionally, in any of the preceding aspects, another implementation of the aspect provides, wherein the image data chunks are associated with seven layers of the interlaced image file, and wherein the packet is a jumbo packet that includes the entire interlaced image file.

Optionally, in any of the preceding aspects, another implementation of the aspect provides, further comprising: assigning, by the one or more processors, a layer priority level to each layer, wherein each successive layer receives a decreasing priority level; ordering, by the processor, the chunks of each layer based on a layer priority level; and positioning, by the processors, the chunks of each layer prior to the IEND chunk or subsequent to the IEND chunk based on the priority level of the each layer.

Optionally, in any of the preceding aspects, another implementation of the aspect provides, wherein the IEND chunk indicates a threshold beyond which no packet wash can be applied when proceeding from the tail of the packet to the head of the packet.

Optionally, in any of the preceding aspects, another implementation of the aspect provides, wherein the IEND chunk is not positioned as a last chunk in the packet.

Optionally, in any of the preceding aspects, another implementation of the aspect provides, further comprising positioning a second IEND chunk as a last chunk in the packet.

Optionally, in any of the preceding aspects, another implementation of the aspect provides, wherein the interlaced image file is a Portable Network Graphics (PNG) file.

In an embodiment, the disclosure includes a method implemented by a transit node, the method comprising: receiving, by a receiver of the transit node, a packet containing data associated with an interlaced image file, the packet including chunks arranged in a priority order of priority with critical chunks positioned at a head of the packet, an IEND chunk positioned as a last critical chunk, and ancillary chunks positioned at a tail of the packet after the IEND chunk; dropping, by the one or more processors, ancillary chunks from the packet as part of a packet wash until the packets is transmissible; and transmitting, by a transmitter of the transit node, the packet toward an image destination.

Network qualitative communication is a network paradigm configured to mitigate data loss in a network due to network congestion. In a network configured for network qualitative communication, network nodes are configured to perform a packet wash operation. A packet wash is performed when a packet would otherwise be dropped due to network congestion. Instead of dropping the entire packet, the packet wash removes portions of the packet, which can be called chunks. This has the effect of reducing the size of the packet until that packet is small enough to be handled by the network in spite of the congestion (or similarly, a group of packets are small enough to be handled). The chunks of the packets can be arranged in order of priority so that the most important information is preserved while the least important information is discarded during the packet wash operation. As a result, the most important information in a packet may still be successfully transmitted through the network instead of being dropped. Such a packet wash operation is not designed to operate on interlaced images, such as images coded according to PNG. Specifically, a PNG file can separate an image into seven reduced images. Each image can be sent in a separate stream of packet(s). Further, metadata describing the image can be attached to one or more of the relevant streams. However, none of the data is arranged based on a priority. Accordingly, a packet wash operation may not be directly applied to a PNG data packet as the packet wash may be unable to determine which data can be discarded and which data should be maintained. Further, in some cases users may be willing to accept the loss of the functionality associated with certain portions of the metadata and/or may be willing to accept the loss image quality associated with the loss of certain layers when such loss will speed up image transmission. However, PNG and related interlacing mechanisms are not natively designed to prioritize data to allow for such a loss.

The present example includes a mechanism to arrange interlaced image data according to a priority so that a packet wash may be applied to corresponding packets. For example, a PNG file employs seven layers of image data as well as various types of metadata. Such data is stored in chunks. The disclosed mechanism designates each chunk as either critical or ancillary. Critical chunks are positioned at the head of a corresponding packet and ancillary chunks are positioned toward the tail of the corresponding packet. A packet wash can then remove the ancillary chunks as desired to overcome network congestion. PNG standards generally place an IEND chunk as the last chunk in a packet. Accordingly, the present mechanism places the IEND chunk as the last critical chunk in the packet and ensures all other critical chunks are positioned before the IEND chunk. As such, such a node may assume every chunk after the IEND chunk is ancillary and can be removed by a packet wash to overcome congestion. In another example, the packet source (e.g., encoder/content server) can designate chunks as critical or ancillary based on parameters in an image file request from the destination (e.g., decoder).

In another example, one or more of the layers containing the reduced images can be designated as ancillary. In such a case, the IDAT chunks containing critical layers are designated as critical and IDAT chunks containing non-critical layers can be designated as ancillary. In one example, each of the seven layers of the image file can be transmitted in packets in separate data streams. The packet wash can then be applied to each packet as desired. For example, when a packet is part of a data stream containing a non-critical layer, the packet wash can remove the metadata related to ancillary chunks from the packet first and then the IDAT chunks in the packet as desired to overcome congestion. In another example, the entire image file can be included in a jumbo packet, for example according to a New IP paradigm. Further, layers may each be assigned a priority level (e.g., a numeric value), where all priority values equal to or above a designated level are critical and all priority values below the designated level are ancillary. In such a case, the packet can be arranged with critical chunks including chunks of critical layers prior to the IEND chunk. The non-critical layers can be positioned after the IEND chunk in order of priority, and the metadata related ancillary chunks can be positioned at the end of the packet. In this way, a packet wash prioritizes dropping metadata first and then dropping image quality from lower to higher priority. In each of these examples, the receiver may receive a packet with ancillary chunks positioned after the IEND chunk, for example when packet washing is not needed and/or when not all of the ancillary chunks are dropped. In such a case, the receiver can reorder the data to place the IEND chunk as the last chunk in order before decoding the image data. In this way, the file is rearranged to comply with PNG standards before being sent to the decoder. The preceding examples allow a requestor to receive a requested image at a lower quality and/or with reduced functionality in case of network congestion instead of receiving nothing due to complete packet drop(s). This mechanism may provide a better user experience. Further, this mechanism may allow packet chunk drops to be prioritized based on a user request. Accordingly, the disclosed mechanisms may also reduce the incidence of re-requests for the image by the user, and hence reduce network traffic and corresponding network congestion. As such, the present mechanisms create additional functionality and reduce processor, memory, and/or network resource usage by an encoder, a content server, a source, a decoder, a destination, and/or an intermediate network node in a communication network.

Optionally, in any of the preceding aspects, another implementation of the aspect provides, wherein the ancillary chunks are dropped starting at the tail of the packet and progressing toward the head of the packet.

Optionally, in any of the preceding aspects, another implementation of the aspect provides, further comprising identifying ancillary chunks eligible for dropping based on a position of the IEND chunk.

Optionally, in any of the preceding aspects, another implementation of the aspect provides, wherein the critical chunks include an IHDR chunk, a PLTE chunk, IDAT chunks, the LEND chunk, or combinations thereof.

Optionally, in any of the preceding aspects, another implementation of the aspect provides, wherein the ancillary chunks include a tRNS chunk, a cHRM chunk, a gAMA chunk, an iCCP chunk, a sBIT chunk, a sRGB chunk, an iTXt chunk, a tEXt chunk, a zTXt chunk, a bKGD chunk, a hIST chunk, an pHYs chunk, a sPLT chunk, a tIME chunk, or combinations thereof.

Optionally, in any of the preceding aspects, another implementation of the aspect provides, wherein the interlaced image file includes a plurality of layers, and wherein at least one chunk in the packet contains image data of a layer that is designated as ancillary.

Optionally, in any of the preceding aspects, another implementation of the aspect provides, wherein the packet corresponds to a stream of packets associated with one layer of the interlaced image file.

Optionally, in any of the preceding aspects, another implementation of the aspect provides, wherein the packet is a jumbo packet that includes the entire interlaced image file.

Optionally, in any of the preceding aspects, another implementation of the aspect provides, wherein the LEND chunk indicates a threshold beyond which no packet wash can be applied when proceeding from the tail of the packet to the head of the packet.

Optionally, in any of the preceding aspects, another implementation of the aspect provides, wherein the LEND chunk is not positioned as a last chunk in the packet.

Optionally, in any of the preceding aspects, another implementation of the aspect provides, wherein a second LEND chunk is positioned as a last chunk in the packet.

Optionally, in any of the preceding aspects, another implementation of the aspect provides, wherein the interlaced image file is a PNG file.

In an embodiment, the disclosure includes a method implemented by an image destination, the method comprising: receiving, by a receiver of the image destination, a packet containing data associated with an interlaced image file, wherein chunks of the packet are arranged in a distinct order according to a priority of the chunks and their designation as critical or ancillary; and decoding, by the processors, the interlaced image file based on the packet.

Network qualitative communication is a network paradigm configured to mitigate data loss in a network due to network congestion. In a network configured for network qualitative communication, network nodes are configured to perform a packet wash operation. A packet wash is performed when a packet would otherwise be dropped due to network congestion. Instead of dropping the entire packet, the packet wash removes portions of the packet, which can be called chunks. This has the effect of reducing the size of the packet until that packet is small enough to be handled by the network in spite of the congestion (or similarly, a group of packets are small enough to be handled). The chunks of the packets can be arranged in order of priority so that the most important information is preserved while the least important information is discarded during the packet wash operation. As a result, the most important information in a packet may still be successfully transmitted through the network instead of being dropped. Such a packet wash operation is not designed to operate on interlaced images, such as images coded according to PNG. Specifically, a PNG file can separate an image into seven reduced images. Each image can be sent in a separate stream of packet(s). Further, metadata describing the image can be attached to one or more of the relevant streams. However, none of the data is arranged based on a priority. Accordingly, a packet wash operation may not be directly applied to a PNG data packet as the packet wash may be unable to determine which data can be discarded and which data should be maintained. Further, in some cases users may be willing to accept the loss of the functionality associated with certain portions of the metadata and/or may be willing to accept the loss image quality associated with the loss of certain layers when such loss will speed up image transmission. However, PNG and related interlacing mechanisms are not natively designed to prioritize data to allow for such a loss.

The present example includes a mechanism to arrange interlaced image data according to a priority so that a packet wash may be applied to corresponding packets. For example, a PNG file employs seven layers of image data as well as various types of metadata. Such data is stored in chunks. The disclosed mechanism designates each chunk as either critical or ancillary. Critical chunks are positioned at the head of a corresponding packet and ancillary chunks are positioned toward the tail of the corresponding packet. A packet wash can then remove the ancillary chunks as desired to overcome network congestion. PNG standards generally place an IEND chunk as the last chunk in a packet. Accordingly, the present mechanism places the IEND chunk as the last critical chunk in the packet and ensures all other critical chunks are positioned before the IEND chunk. As such, such a node may assume every chunk after the IEND chunk is ancillary and can be removed by a packet wash to overcome congestion. In another example, the packet source (e.g., encoder/content server) can designate chunks as critical or ancillary based on parameters in an image file request from the destination (e.g., decoder).

In another example, one or more of the layers containing the reduced images can be designated as ancillary. In such a case, the IDAT chunks containing critical layers are designated as critical and IDAT chunks containing non-critical layers can be designated as ancillary. In one example, each of the seven layers of the image file can be transmitted in packets in separate data streams. The packet wash can then be applied to each packet as desired. For example, when a packet is part of a data stream containing a non-critical layer, the packet wash can remove the metadata related to ancillary chunks from the packet first and then the IDAT chunks in the packet as desired to overcome congestion. In another example, the entire image file can be included in a jumbo packet, for example according to a New IP paradigm. Further, layers may each be assigned a priority level (e.g., a numeric value), where all priority values equal to or above a designated level are critical and all priority values below the designated level are ancillary. In such a case, the packet can be arranged with critical chunks including chunks of critical layers prior to the IEND chunk. The non-critical layers can be positioned after the IEND chunk in order of priority, and the metadata related ancillary chunks can be positioned at the end of the packet. In this way, a packet wash prioritizes dropping metadata first and then dropping image quality from lower to higher priority. In each of these examples, the receiver may receive a packet with ancillary chunks positioned after the IEND chunk, for example when packet washing is not needed and/or when not all of the ancillary chunks are dropped. In such a case, the receiver can reorder the data to place the IEND chunk as the last chunk in order before decoding the image data. In this way, the file is rearranged to comply with PNG standards before being sent to the decoder. The preceding examples allow a requestor to receive a requested image at a lower quality and/or with reduced functionality in case of network congestion instead of receiving nothing due to complete packet drop(s). This mechanism may provide a better user experience. Further, this mechanism may allow packet chunk drops to be prioritized based on a user request. Accordingly, the disclosed mechanisms may also reduce the incidence of re-requests for the image by the user, and hence reduce network traffic and corresponding network congestion. As such, the present mechanisms create additional functionality and reduce processor, memory, and/or network resource usage by an encoder, a content server, a source, a decoder, a destination, and/or an intermediate network node in a communication network.

Optionally, in any of the preceding aspects, another implementation of the aspect provides, wherein critical chunks are positioned at a head of the packet, an IEND chunk is positioned as a last critical chunk in the packet, and one or more ancillary chunks are positioned at a tail of the packet after the IEND chunk.

Optionally, in any of the preceding aspects, another implementation of the aspect provides, further comprising reordering, by one or more processors of the image destination, the packet to position the IEND chunk as a last chunk in the packet.

Optionally, in any of the preceding aspects, another implementation of the aspect provides, wherein all critical chunks of a layer are positioned before all ancillary chunks of the layer.

Optionally, in any of the preceding aspects, another implementation of the aspect provides, wherein a chunk of a lower priority layer is positioned before an ancillary chunk of a higher priority layer.

Optionally, in any of the preceding aspects, another implementation of the aspect provides, wherein reordering includes positioning one or more ancillary chunks prior to chunks containing image data.

Optionally, in any of the preceding aspects, another implementation of the aspect provides, wherein the critical chunks include an IHDR chunk, a PLTE chunk, IDAT chunks, the LEND chunk, or combinations thereof.

Optionally, in any of the preceding aspects, another implementation of the aspect provides, wherein the ancillary chunks include a tRNS chunk, a cHRM chunk, a gAMA chunk, an iCCP chunk, a sBIT chunk, a sRGB chunk, an iTXt chunk, a tEXt chunk, a zTXt chunk, a bKGD chunk, a hIST chunk, an pHYs chunk, a sPLT chunk, a tIME chunk, or combinations thereof.

Optionally, in any of the preceding aspects, another implementation of the aspect provides, wherein the packet, as received, has lost one or more ancillary chunks during transit to a packet wash operation in a network.

Optionally, in any of the preceding aspects, another implementation of the aspect provides, further comprising transmitting, by a transmitter of the image destination, a request for the interlaced image file prior to receiving the interlaced image file, wherein the request contains parameters to indicate an image smoothness requirement, an image attribute preference, a decoding capability, or combinations thereof.

Optionally, in any of the preceding aspects, another implementation of the aspect provides, wherein the interlaced image file includes a plurality of layers, and wherein at least one chunk in the packet contains image data of a layer that is designated as ancillary.

Optionally, in any of the preceding aspects, another implementation of the aspect provides, wherein the packet corresponds to a stream of packets associated with one layer of the interlaced image file.

Optionally, in any of the preceding aspects, another implementation of the aspect provides, wherein the packet is a jumbo packet that includes the entire interlaced image file.

Optionally, in any of the preceding aspects, another implementation of the aspect provides, further comprising dropping, by the processors, one or more ancillary chunks from the packet prior to decoding to support reduced hardware resource usage during decoding.

Optionally, in any of the preceding aspects, another implementation of the aspect provides, wherein a position of the IEND chunk upon receipt indicates a threshold beyond which no packet wash can be applied when proceeding from the tail of the packet to the head of the packet.

Optionally, in any of the preceding aspects, another implementation of the aspect provides, wherein the IEND chunk is not positioned as a last chunk in the packet upon receipt.

Optionally, in any of the preceding aspects, another implementation of the aspect provides, wherein the interlaced image file is a PNG file.

In an embodiment, the disclosure includes an image processing device comprising: a processor, a receiver coupled to the processor, a memory coupled to the processor, and a transmitter coupled to the processor, wherein the processor, receiver, memory, and transmitter are configured to perform the method of any of the preceding aspects.

In an embodiment, the disclosure includes a non-transitory computer readable medium comprising a computer program product for use by a computing device, the computer program product comprising computer executable instructions stored on the non-transitory computer readable medium such that when executed by a processor cause the coding device to perform the method of any of the preceding aspects.

In an embodiment, the disclosure includes an image source comprising: a memory storing instructions; and at least one processor in communication with the memory, the at least one processor configured, upon execution of the instructions, to perform the following steps: i) designating each chunk of a plurality of chunks of an interlaced image file as critical or ancillary; ii) positioning the chunks in a packet in a priority order according to a priority of the chunks and their designation as critical or ancillary; and iii) transmitting the packet toward an image destination.

Network qualitative communication is a network paradigm configured to mitigate data loss in a network due to network congestion. In a network configured for network qualitative communication, network nodes are configured to perform a packet wash operation. A packet wash is performed when a packet would otherwise be dropped due to network congestion. Instead of dropping the entire packet, the packet wash removes portions of the packet, which can be called chunks. This has the effect of reducing the size of the packet until that packet is small enough to be handled by the network in spite of the congestion (or similarly, a group of packets are small enough to be handled). The chunks of the packets can be arranged in order of priority so that the most important information is preserved while the least important information is discarded during the packet wash operation. As a result, the most important information in a packet may still be successfully transmitted through the network instead of being dropped. Such a packet wash operation is not designed to operate on interlaced images, such as images coded according to PNG. Specifically, a PNG file can separate an image into seven reduced images. Each image can be sent in a separate stream of packet(s). Further, metadata describing the image can be attached to one or more of the relevant streams. However, none of the data is arranged based on a priority. Accordingly, a packet wash operation may not be directly applied to a PNG data packet as the packet wash may be unable to determine which data can be discarded and which data should be maintained. Further, in some cases users may be willing to accept the loss of the functionality associated with certain portions of the metadata and/or may be willing to accept the loss image quality associated with the loss of certain layers when such loss will speed up image transmission. However, PNG and related interlacing mechanisms are not natively designed to prioritize data to allow for such a loss.

The present example includes a mechanism to arrange interlaced image data according to a priority so that a packet wash may be applied to corresponding packets. For example, a PNG file employs seven layers of image data as well as various types of metadata. Such data is stored in chunks. The disclosed mechanism designates each chunk as either critical or ancillary. Critical chunks are positioned at the head of a corresponding packet and ancillary chunks are positioned toward the tail of the corresponding packet. A packet wash can then remove the ancillary chunks as desired to overcome network congestion. PNG standards generally place an IEND chunk as the last chunk in a packet. Accordingly, the present mechanism places the IEND chunk as the last critical chunk in the packet and ensures all other critical chunks are positioned before the IEND chunk. As such, such a node may assume every chunk after the IEND chunk is ancillary and can be removed by a packet wash to overcome congestion. In another example, the packet source (e.g., encoder/content server) can designate chunks as critical or ancillary based on parameters in an image file request from the destination (e.g., decoder).

In another example, one or more of the layers containing the reduced images can be designated as ancillary. In such a case, the IDAT chunks containing critical layers are designated as critical and IDAT chunks containing non-critical layers can be designated as ancillary. In one example, each of the seven layers of the image file can be transmitted in packets in separate data streams. The packet wash can then be applied to each packet as desired. For example, when a packet is part of a data stream containing a non-critical layer, the packet wash can remove the metadata related to ancillary chunks from the packet first and then the IDAT chunks in the packet as desired to overcome congestion. In another example, the entire image file can be included in a jumbo packet, for example according to a New IP paradigm. Further, layers may each be assigned a priority level (e.g., a numeric value), where all priority values equal to or above a designated level are critical and all priority values below the designated level are ancillary. In such a case, the packet can be arranged with critical chunks including chunks of critical layers prior to the IEND chunk. The non-critical layers can be positioned after the IEND chunk in order of priority, and the metadata related ancillary chunks can be positioned at the end of the packet. In this way, a packet wash prioritizes dropping metadata first and then dropping image quality from lower to higher priority. In each of these examples, the receiver may receive a packet with ancillary chunks positioned after the IEND chunk, for example when packet washing is not needed and/or when not all of the ancillary chunks are dropped. In such a case, the receiver can reorder the data to place the IEND chunk as the last chunk in order before decoding the image data. In this way, the file is rearranged to comply with PNG standards before being sent to the decoder. The preceding examples allow a requestor to receive a requested image at a lower quality and/or with reduced functionality in case of network congestion instead of receiving nothing due to complete packet drop(s). This mechanism may provide a better user experience. Further, this mechanism may allow packet chunk drops to be prioritized based on a user request. Accordingly, the disclosed mechanisms may also reduce the incidence of re-requests for the image by the user, and hence reduce network traffic and corresponding network congestion. As such, the present mechanisms create additional functionality and reduce processor, memory, and/or network resource usage by an encoder, a content server, a source, a decoder, a destination, and/or an intermediate network node in a communication network.

Optionally, in any of the preceding aspects, another implementation of the aspect provides, wherein the image source is further configured to perform the method of any of the preceding aspects.

In an embodiment, the disclosure includes a transit node comprising: a memory storing instructions; and at least one processor in communication with the memory, the at least one processor configured, upon execution of the instructions, to perform the following steps: i) receiving a packet containing data associated with an interlaced image file, the packet being including chunks arranged in an order of priority with critical chunks positioned at a head of the packet, an image trailer (IEND) chunk positioned as a last critical chunk, and ancillary chunks positioned at a tail of the packet after the IEND chunk; ii) dropping ancillary chunks from the packet as part of a packet wash until the packet is transmissible; and iii) transmitting the packet toward an image destination.

Network qualitative communication is a network paradigm configured to mitigate data loss in a network due to network congestion. In a network configured for network qualitative communication, network nodes are configured to perform a packet wash operation. A packet wash is performed when a packet would otherwise be dropped due to network congestion. Instead of dropping the entire packet, the packet wash removes portions of the packet, which can be called chunks. This has the effect of reducing the size of the packet until that packet is small enough to be handled by the network in spite of the congestion (or similarly, a group of packets are small enough to be handled). The chunks of the packets can be arranged in order of priority so that the most important information is preserved while the least important information is discarded during the packet wash operation. As a result, the most important information in a packet may still be successfully transmitted through the network instead of being dropped. Such a packet wash operation is not designed to operate on interlaced images, such as images coded according to PNG. Specifically, a PNG file can separate an image into seven reduced images. Each image can be sent in a separate stream of packet(s). Further, metadata describing the image can be attached to one or more of the relevant streams. However, none of the data is arranged based on a priority. Accordingly, a packet wash operation may not be directly applied to a PNG data packet as the packet wash may be unable to determine which data can be discarded and which data should be maintained. Further, in some cases users may be willing to accept the loss of the functionality associated with certain portions of the metadata and/or may be willing to accept the loss image quality associated with the loss of certain layers when such loss will speed up image transmission. However, PNG and related interlacing mechanisms are not natively designed to prioritize data to allow for such a loss.

The present example includes a mechanism to arrange interlaced image data according to a priority so that a packet wash may be applied to corresponding packets. For example, a PNG file employs seven layers of image data as well as various types of metadata. Such data is stored in chunks. The disclosed mechanism designates each chunk as either critical or ancillary. Critical chunks are positioned at the head of a corresponding packet and ancillary chunks are positioned toward the tail of the corresponding packet. A packet wash can then remove the ancillary chunks as desired to overcome network congestion. PNG standards generally place an IEND chunk as the last chunk in a packet. Accordingly, the present mechanism places the IEND chunk as the last critical chunk in the packet and ensures all other critical chunks are positioned before the IEND chunk. As such, such a node may assume every chunk after the IEND chunk is ancillary and can be removed by a packet wash to overcome congestion. In another example, the packet source (e.g., encoder/content server) can designate chunks as critical or ancillary based on parameters in an image file request from the destination (e.g., decoder).

In another example, one or more of the layers containing the reduced images can be designated as ancillary. In such a case, the IDAT chunks containing critical layers are designated as critical and IDAT chunks containing non-critical layers can be designated as ancillary. In one example, each of the seven layers of the image file can be transmitted in packets in separate data streams. The packet wash can then be applied to each packet as desired. For example, when a packet is part of a data stream containing a non-critical layer, the packet wash can remove the metadata related to ancillary chunks from the packet first and then the IDAT chunks in the packet as desired to overcome congestion. In another example, the entire image file can be included in a jumbo packet, for example according to a New IP paradigm. Further, layers may each be assigned a priority level (e.g., a numeric value), where all priority values equal to or above a designated level are critical and all priority values below the designated level are ancillary. In such a case, the packet can be arranged with critical chunks including chunks of critical layers prior to the IEND chunk. The non-critical layers can be positioned after the IEND chunk in order of priority, and the metadata related ancillary chunks can be positioned at the end of the packet. In this way, a packet wash prioritizes dropping metadata first and then dropping image quality from lower to higher priority. In each of these examples, the receiver may receive a packet with ancillary chunks positioned after the IEND chunk, for example when packet washing is not needed and/or when not all of the ancillary chunks are dropped. In such a case, the receiver can reorder the data to place the IEND chunk as the last chunk in order before decoding the image data. In this way, the file is rearranged to comply with PNG standards before being sent to the decoder. The preceding examples allow a requestor to receive a requested image at a lower quality and/or with reduced functionality in case of network congestion instead of receiving nothing due to complete packet drop(s). This mechanism may provide a better user experience. Further, this mechanism may allow packet chunk drops to be prioritized based on a user request. Accordingly, the disclosed mechanisms may also reduce the incidence of re-requests for the image by the user, and hence reduce network traffic and corresponding network congestion. As such, the present mechanisms create additional functionality and reduce processor, memory, and/or network resource usage by an encoder, a content server, a source, a decoder, a destination, and/or an intermediate network node in a communication network.

Optionally, in any of the preceding aspects, another implementation of the aspect provides, wherein the decoder is further configured to perform the method of any of the preceding aspects.

In an embodiment, the disclosure includes an image destination comprising: a receiving means for receiving a packet containing data associated with an interlaced image file, wherein chunks of the packet are arranged in a distinct order according to a priority of the chunks and their designation as critical or ancillary; and a decoding means for decoding the interlaced image file based on the packet.

Network qualitative communication is a network paradigm configured to mitigate data loss in a network due to network congestion. In a network configured for network qualitative communication, network nodes are configured to perform a packet wash operation. A packet wash is performed when a packet would otherwise be dropped due to network congestion. Instead of dropping the entire packet, the packet wash removes portions of the packet, which can be called chunks. This has the effect of reducing the size of the packet until that packet is small enough to be handled by the network in spite of the congestion (or similarly, a group of packets are small enough to be handled). The chunks of the packets can be arranged in order of priority so that the most important information is preserved while the least important information is discarded during the packet wash operation. As a result, the most important information in a packet may still be successfully transmitted through the network instead of being dropped. Such a packet wash operation is not designed to operate on interlaced images, such as images coded according to PNG. Specifically, a PNG file can separate an image into seven reduced images. Each image can be sent in a separate stream of packet(s). Further, metadata describing the image can be attached to one or more of the relevant streams. However, none of the data is arranged based on a priority. Accordingly, a packet wash operation may not be directly applied to a PNG data packet as the packet wash may be unable to determine which data can be discarded and which data should be maintained. Further, in some cases users may be willing to accept the loss of the functionality associated with certain portions of the metadata and/or may be willing to accept the loss image quality associated with the loss of certain layers when such loss will speed up image transmission. However, PNG and related interlacing mechanisms are not natively designed to prioritize data to allow for such a loss.

The present example includes a mechanism to arrange interlaced image data according to a priority so that a packet wash may be applied to corresponding packets. For example, a PNG file employs seven layers of image data as well as various types of metadata. Such data is stored in chunks. The disclosed mechanism designates each chunk as either critical or ancillary. Critical chunks are positioned at the head of a corresponding packet and ancillary chunks are positioned toward the tail of the corresponding packet. A packet wash can then remove the ancillary chunks as desired to overcome network congestion. PNG standards generally place an IEND chunk as the last chunk in a packet. Accordingly, the present mechanism places the IEND chunk as the last critical chunk in the packet and ensures all other critical chunks are positioned before the IEND chunk. As such, such a node may assume every chunk after the IEND chunk is ancillary and can be removed by a packet wash to overcome congestion. In another example, the packet source (e.g., encoder/content server) can designate chunks as critical or ancillary based on parameters in an image file request from the destination (e.g., decoder).

In another example, one or more of the layers containing the reduced images can be designated as ancillary. In such a case, the IDAT chunks containing critical layers are designated as critical and IDAT chunks containing non-critical layers can be designated as ancillary. In one example, each of the seven layers of the image file can be transmitted in packets in separate data streams. The packet wash can then be applied to each packet as desired. For example, when a packet is part of a data stream containing a non-critical layer, the packet wash can remove the metadata related to ancillary chunks from the packet first and then the IDAT chunks in the packet as desired to overcome congestion. In another example, the entire image file can be included in a jumbo packet, for example according to a New IP paradigm. Further, layers may each be assigned a priority level (e.g., a numeric value), where all priority values equal to or above a designated level are critical and all priority values below the designated level are ancillary. In such a case, the packet can be arranged with critical chunks including chunks of critical layers prior to the IEND chunk. The non-critical layers can be positioned after the IEND chunk in order of priority, and the metadata related ancillary chunks can be positioned at the end of the packet. In this way, a packet wash prioritizes dropping metadata first and then dropping image quality from lower to higher priority. In each of these examples, the receiver may receive a packet with ancillary chunks positioned after the IEND chunk, for example when packet washing is not needed and/or when not all of the ancillary chunks are dropped. In such a case, the receiver can reorder the data to place the IEND chunk as the last chunk in order before decoding the image data. In this way, the file is rearranged to comply with PNG standards before being sent to the decoder. The preceding examples allow a requestor to receive a requested image at a lower quality and/or with reduced functionality in case of network congestion instead of receiving nothing due to complete packet drop(s). This mechanism may provide a better user experience. Further, this mechanism may allow packet chunk drops to be prioritized based on a user request. Accordingly, the disclosed mechanisms may also reduce the incidence of re-requests for the image by the user, and hence reduce network traffic and corresponding network congestion. As such, the present mechanisms create additional functionality and reduce processor, memory, and/or network resource usage by an encoder, a content server, a source, a decoder, a destination, and/or an intermediate network node in a communication network.

Optionally, in any of the preceding aspects, another implementation of the aspect provides, wherein the decoder is further configured to perform the method of any of the preceding aspects.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an example network configured to perform qualitative communication.

FIG. 2 illustrates an example mechanism of performing a packet wash to support qualitative communication.

FIG. 3 is a schematic diagram illustrating an example of an interlacing mechanism for coding an image, such as a PNG image, as multiple layers of reduced images.

FIG. 4 is a schematic diagram illustrating an example of ordering constraints in PNG files.

FIG. 5 is a schematic diagram illustrating an example mechanism for arranging interlaced image data into multi-layer streams that support a packet wash.

FIG. 6 is a schematic diagram illustrating an example mechanism for arranging interlaced image data into a single jumbo packet that supports a packet wash.

FIG. 7 is a schematic diagram of an example image processing device.

FIG. 8 is a flowchart of an example method of ordering interlaced image data to support packet washing as part of qualitative communication.

FIG. 9 is a flowchart of an example method of performing a packet wash of interlaced image data.

FIG. 10 is a flowchart of an example method of decoding interlaced image data from an order supporting packet washing as part of qualitative communication.

FIG. 11 is a schematic diagram of an example system for ordering interlaced image data to support packet washing as part of qualitative communication.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

The following terms are defined as follows unless used in a contrary context herein. Specifically, the following definitions are intended to provide additional clarity to the present disclosure. However, terms may be described differently in different contexts. Accordingly, the following definitions should be considered as a supplement and should not be considered to limit any other definitions of descriptions provided for such terms herein.

Network qualitative communication is a network paradigm configured to mitigate data loss in a network due to network congestion. In a network configured for network qualitative communication, network nodes are configured to perform a packet wash operation. A packet wash is performed when a packet would otherwise be dropped due to network congestion. Instead of dropping the entire packet, the packet wash removes portions of the packet, which can be called chunks. This has the effect of reducing the size of the packet until that packet is small enough to be handled by the network in spite of the congestion (or similarly, a group of packets are small enough to be handled). The chunks of the packets can be arranged in order of priority so that the most important information is preserved while the least important information is discarded during the packet wash operation. As a result, the most important information in a packet may still be successfully transmitted through the network instead of being dropped. Such a packet wash operation is not designed to operate on interlaced images, such as images coded according to Portable Network Graphics (PNG).

Specifically, a PNG file can separate an image into seven reduced images. Each image can be sent in a separate stream of packet(s). Further, metadata describing the image can be attached to one or more of the relevant streams. However, none of the data is arranged based on a priority. Accordingly, a packet wash operation may not be directly applied to a PNG data packet as the packet wash may be unable to determine which data can be discarded and which data should be maintained. Further, in some cases users may be willing to accept the loss of the functionality associated with certain portions of the metadata and/or may be willing to accept the loss image quality associated with the loss of certain layers when such loss will speed up image transmission. However, PNG and related interlacing mechanisms are not natively designed to prioritize data to allow for such a loss.

Disclosed herein is a mechanism to arrange interlaced image data according to a priority so that a packet wash may be applied to corresponding packets. For example, a PNG file employs seven layers of image data as well as various types of metadata. Such data is stored in chunks. The disclosed mechanism designates each chunk as either critical or ancillary. Critical chunks are positioned at the head of a corresponding packet and ancillary chunks are positioned toward the tail of the corresponding packet. A packet wash can then remove the ancillary chunks as desired to overcome network congestion. In a specific example, a packet for a PNG file may include an image header (IHDR) chunk, a palette table (PLTE) chunk, image data (IDAT) chunks, and/or an image trailer (IEND) chunk, which may all be designated as critical. PNG standards generally placed the IEND chunk as the last chunk in a packet. Accordingly, the present mechanism places the IEND chunk as the last critical chunk in the packet and ensures all other critical chunks are positioned before the IEND chunk. As such, such a node may assume every chunk after the IEND chunk is ancillary and can be removed by a packet wash to overcome congestion. Examples of ancillary chunks may include a transparency information (tRNS) chunk, a chromaticity (cHRM) chunk, a gamma value (gAMA) chunk, an international color consortium (iCCP) chunk, a significant bits (sBIT) chunk, a standard red green blue (sRGB) chunk, a text keywork (iTXt) chunk, a text (tEXt) chunk, a compressed text (zTXt) chunk, a default background (bKGD) chunk, a histogram (hIST) chunk, an intended pixel size (pHYs) chunk, a suggested palette (sPLT) chunk, and/or a time changed (tIME) chunk. In another example, the packet source (e.g., encoder/content server) can designate chunks as critical or ancillary based on parameters in an image file request from the destination (e.g., decoder). It should be noted that the terms critical or ancillary may be substituted with other terms, such as primary and tertiary, respectively, as desired within the scope of the present disclosure.

In another example, one or more of the layers containing the reduced images can be designated as ancillary. In such a case, the IDAT chunks containing critical layers are designated as critical and IDAT chunks containing non-critical layers can be designated as ancillary. In one example, each of the seven layers of the image file can be transmitted in packets in separate data streams. The packet wash can then be applied to each packet as desired. For example, when a packet is part of a data stream containing a non-critical layer, the packet wash can remove the metadata related to ancillary chunks from the packet first and then the IDAT chunks in the packet as desired to overcome congestion. In another example, the entire image file can be included in a jumbo packet, for example according to a New internet protocol (IP) paradigm. Further, layers may each be assigned a priority level (e.g., a numeric value), where all priority values equal to or above a designated level are critical and all priority values below the designated level are ancillary. In such a case, the packet can be arranged with critical chunks including chunks of critical layers prior to the LEND chunk. The non-critical layers can be positioned after the LEND chunk in order of priority, and the metadata related ancillary chunks can be positioned at the end of the packet. In this way, a packet wash prioritizes dropping metadata first and then dropping image quality from lower to higher priority. In each of these examples, the receiver may receive a packet with ancillary chunks positioned after the LEND chunk, for example when packet washing is not needed and/or when not all of the ancillary chunks are dropped. In such a case, the receiver can reorder the data to place the LEND chunk as the last chunk in order before decoding the image data. In this way, the file is rearranged to comply with PNG standards before being sent to the decoder.

The preceding examples allow a requestor to receive a requested image at a lower quality and/or with reduced functionality in case of network congestion instead of receiving nothing due to complete packet drop(s). This mechanism may provide a better user experience. Further, this mechanism may allow packet chunk drops to be prioritized based on a user request. Accordingly, the disclosed mechanisms may also reduce the incidence of re-requests for the image by the user, and hence reduce network traffic and corresponding network congestion. As such, the present mechanisms create additional functionality and reduce processor, memory, and/or network resource usage by an encoder, a content server, a source, a decoder, a destination, and/or an intermediate network node in a communication network.

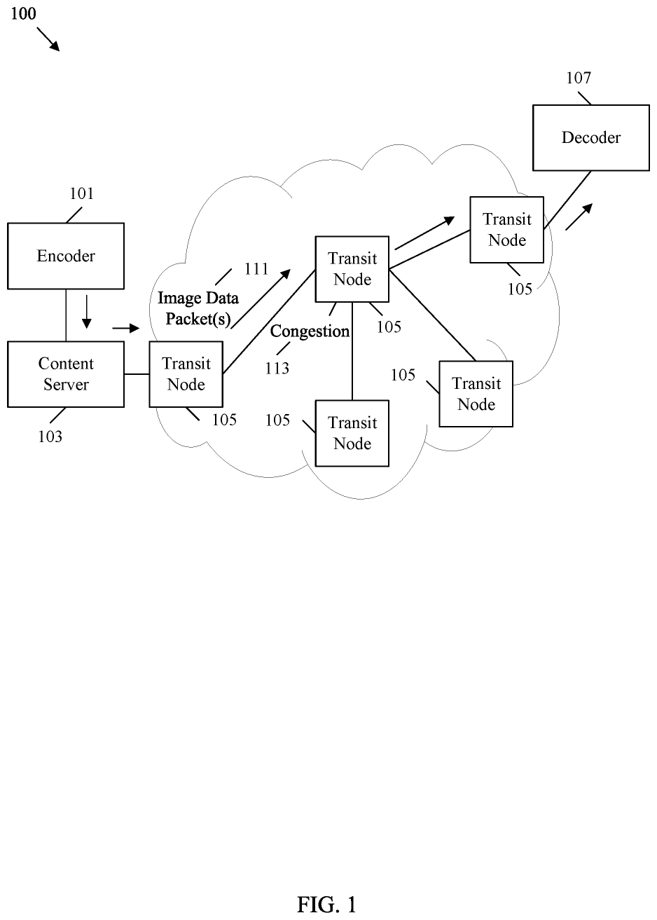

FIG. 1 is a schematic diagram of an example network 100 configured to perform qualitative communication. The network 100 includes an encoder 101, a content server 103, a decoder 107, and a group of interconnected transit nodes 105.

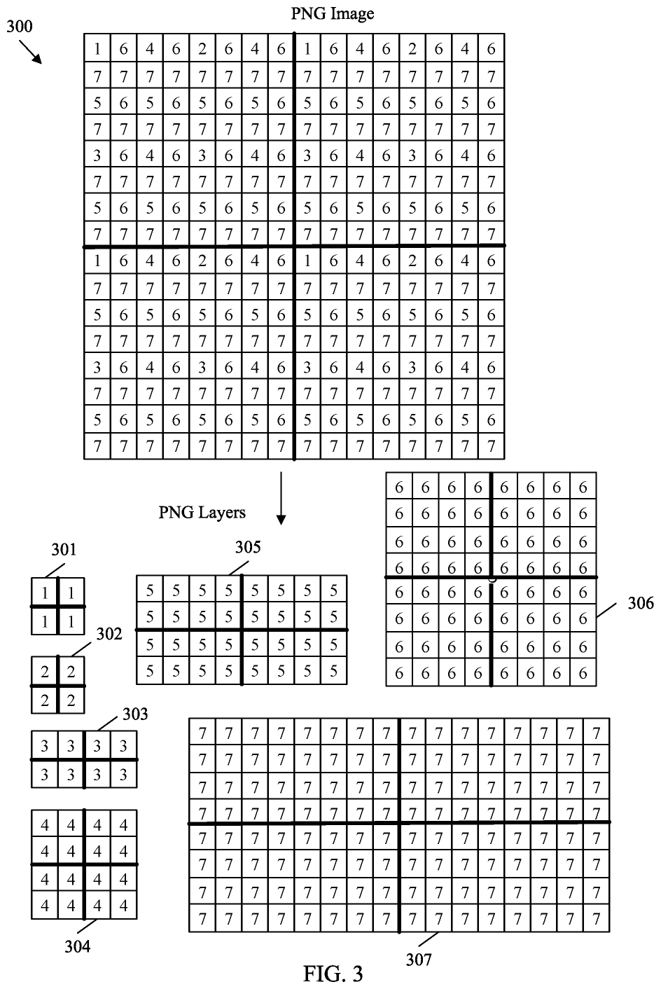

An encoder 101 is any computing device capable of converting raw image data into a predefined image file format, for example to compress and/or add functionality to the image data. The encoder 101 can store and/or transmit the encoded image file toward a decoder. For example, an encoder 101 may be configured to compress video and/or images into a compressed and/or reduced format for transmission over network 100. The encoder 101 can use a lossy or a lossless compression algorithm. The present application focuses on interlaced images, such as a PNG file. When operating on an interlaced image file, the encoder can convert a raw image into multiple reduced images, for example as described in more detail with respect to FIG. 3 below. The encoder 101 can add data corresponding to the reduced images into multiple chunks. As used herein, a chunk is a contiguous set of related data that is arranged for inclusion in a payload of a packet, such as an image data packet 111, for example to support transmission across a network 100. When employing the PNG file format, data from the reduced images may be included in image data (IDAT) chunks. Each of the reduced images contains data describing pixels in an original image.

When encoding, the encoder 101 spreads data describing the pixels of an original image across the various reduced images. Presuming a destination, such as a decoder 107, receives all of the reduced images, the reduced images can be combined to recreate the original image. In the event that any of the reduced images are lost in transit and/or otherwise delayed, the destination can create a degraded version of the original image by combining the reduced images that are received. The original image may also be associated with various metadata. The metadata may describe the encoding of the file to support decoding. As used herein, metadata is a set of data that describes other data. The metadata may also describe information related to the image itself, such as a time and/or location when the image was created/captured. The encoder 101 may also add such metadata into corresponding chunks for transmission along with the image data.

The image and metadata chunks can be included in one or more image data packets 111. An image data packet 111 is a formatted unit of data carried by a network, such as network 100. The data in an image data packet 111 includes and/or pertains to an image file. For example, the reduced images of a PNG file may be split amongst multiple streams of image data packets 111 that are sized for communication based on Internet Protocol (IP) mechanisms. In other examples, an entire PNG file can be stored in a jumbo packet. A jumbo packet is a packet that contains a payload with a size that is greater than a standard maximum transmission unit. As an example, a networking standard referred to as New IP can be employed to implement an image data packet 111, in which case a single image data packet 111 can be implemented as a jumbo packet and can contain an entire PNG file. As used herein, New IP is a framework that employs a header with a contract clause that supports packet and/or stream/flow specific network programming, and that allows for the use of variable length packets. The image data packet(s) 111 can be sent from the encoder 101 to the content server 103. The image data packet(s) 111 can also be sent from the encoder 101 and/or from the content server 103 to the decoder 107 via the transit nodes 105.

A content server 103 is a computing device capable of storing data and making such data available to other network devices upon request. For example, a content server 103 may receive an encoded image file and/or image data packets 111 from an encoder and store such data until such data is requested by a decoder 107. For example, an image file (e.g., in a web page and/or web-based software) may be stored in the content server 103. The content server 103 may transmit an image data packet 111 containing such data to a decoder 107 upon request. A content server 103 is optional equipment. For example, an encoder 101 that live streams content may transmit such content directly to a decoder 107. As a specific example, an encoder 101 being used as part of a teleconference may transmit image data packets 111 to the decoder 107 in real time without employing a content server 103. When used, the content server 103 stores encoded image data, receives a request for the image data, and transmits image data packet(s) 111 on behalf of the encoder 101. In another example, an encoder 101 can be included on the content server 103.

A decoder 107 is any computing device capable of converting a coded image data file into a raw image data, for example, for display/playback to an end user. For example, a decoder 107 may include any device that contains a web browser. The decoder 107 is configured to request image data from the encoder 101 and/or the content server 103 via transit nodes 105. The decoder 107 can then receive the image data packet(s) 111 containing the requested image data, decode the image data packet(s) 111 to reconstruct the image data, and display the image data to a user. For example, the image data displayed to the user may include static image(s), such as a PNG file, video including multiple images, or combinations thereof. For example, the decoder 107 may receive image data packet(s) 111 that describe an original image at the encoder 101. The decoder 107 can read any metadata in the image data packet(s) 111, obtain reduced images from the image data packet(s) 111, and combine the reduced images to generate a copy of the original image for display to an end user. The copy of the image may be created and/or formatted based on information in the metadata. Further, when one or more of the reduced images are lost and/or delayed in transit, the decoder 107 can combine all of the received reduced images to generate a reduced quality version of the original image. In this way, the decoder 107 can display the best available quality version of the image as soon as the data is available. The decoder 107 can then update the image to progressively better quality if/when additional image data packet(s) 111 are received with further reduced images.

The image data packet(s) 111 and any associated requests are communicated between the encoder 101, the decoder 107, and/or the content server 103 via a network of transit nodes 105. A transit node 105 is any network device and/or network node capable of receiving, handling, and/or transmitting a packet containing coded image data, such as an image data packet 111. As a specific example, the transit nodes 105 are configured to transmit a request for image data to the encoder 101 and/or toward the content server 103 from the decoder 107. Further, the transit nodes 105 are configured to transmit the image data packet(s) 111 from the encoder 101 and/or content server 103 toward the decoder 107.

The transit nodes 105 may communicate many flows of data simultaneously. In some cases, an overused transit node 105 may experience congestion 113. Congestion 113 describes a scenario where a transit node 105 or associated link is directed to communicate more network traffic than is supported by the associated hardware. For example, congestion 113 may occur when a transit node 105 begins receiving traffic faster than the transit node 105 can process that traffic. Congestion 113 can also occur when the transit node 105 is directed to transmit more data over a specified output port and/or link than a maximum bandwidth capacity of the output port and/or link. A transit node 105 can manage congestion 113 by storing packets until additional bandwidth is available. However, memory on a transit node 105 is a finite resource and can become overloaded when the congestion 113 becomes severe and/or is consistent over an extended period. Once the transit node 105 exceeds both communication bandwidth and memory capacity, the transit node 105 may be forced to begin dropping packets. A packet drop is a mechanism for purposely discarding a packet during transmission through a network when relevant network resources are insufficient to respond to all demands placed on such network resources.

In some networks, packet drops result in data becoming lost. However, network 100 is configured to employ network qualitative communication. Network qualitative communication is a network paradigm configured to mitigate data loss in a network 100 due to network congestion 113. In a network 100 configured for network qualitative communication, transit nodes 105 are configured to perform a packet wash operation. A packet wash is performed when a packet would otherwise be dropped due to network congestion 113. Instead of dropping the entire packet, the packet wash removes chunks of the packet, other packets, or both. This has the effect of reducing the size of packets that need to be stored/transmitted until that packet can be stored and/or transmitted by the transit node 105 in spite of the congestion 113. The chunks of the packets can be arranged in order of priority so that the most important information is preserved while the least important information is discarded during the packet wash operation. As a result, the most important information in a packet may still be successfully transmitted through the network 100 instead of being dropped.

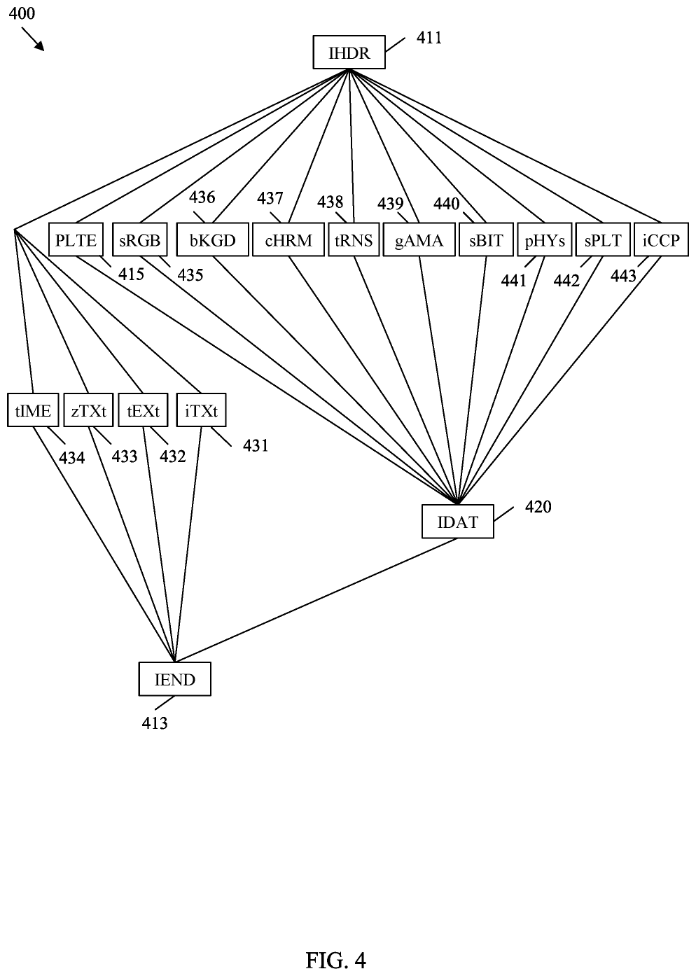

Further, network 100 is configured to employ network qualitative communication principles when transmitting an image data packet 111. Other networks are unable to perform a packet wash on an image data packet because the size and number of image data packets is set when the image data is encoded/compressed. Specifically, the chunks of the image data file are arranged in packets in an order based on various standardized ordering constraints, such as ordering constraints 400 which are described in greater detail with respect to FIG. 4. Such an ordering does not provide any indication of the relative importance of the chunks in the image data packets. Hence, a packet wash cannot determine a priority and therefore the packet wash cannot apply the priority to image data packets that are arranged according to ordering constraints 400 without loss of a random selection of data.

Network 100 is altered to address this problem. The encoder 101 and/or content server 103 can organize chunks in the image data packets 111 in order of priority. The transit nodes 105 can then perform a packet wash as desired to overcome congestion 113 by dropping chunks of an image packet 111 from the packet tail toward the head of the packet. In this way, the decoder 107 receives the image data packet(s) 111 without some of the low priority data instead of losing entire image data packet(s) 111 due to packet drops. For example, the encoder 101 and/or content server 103 can designate chunks as either critical or ancillary. The encoder 101 and/or content server 103 can position critical chunks starting at the head of an image data packet 111 followed by ancillary chunks that proceed toward the tail of the image data packet 111. In an example, an LEND chunk can be used as a last critical chunk that separates the critical chunks from the ancillary chunks. In this way, the transit nodes 105 can perform a packet wash on an image data packet 111 from the tail proceeding toward the head until the image data packet 111 is small enough to transmit despite any congestion 113. When the LEND chunk is reached, the transit node 105 determines that further washing is not allowed and drops the packet when the packet is still too large to send due to the congestion 113, although the last washable chunk can also be designated in other ways, such as with a pointer indicating the last washable portion of a packet. In some examples, certain metadata can be considered ancillary, and hence can be placed at the end of an image data packet 111. Further, in some examples, the encoder 101 and/or content server 103 can determine to set certain reduced images as ancillary, and hence can set IDAT chunks related to those reduced images as ancillary. The designation of critical or ancillary can be predefined and/or determined based on parameters from the decoder 107. In an example, the decoder 107 may also reorder the chunks in the image data packet(s) 111 in order to meet ordering constraints, such as ordering constraints 400, prior to decoding. For example, the decoder 107 may reorder the chunks of each received image data packet 111 to position the LEND chunk as the last chunk in the packet in order to comply with expected ordering used by the decoding process. Further, in some examples, the decoder 107 may include a device that determines to limit hardware resource usage. In an example, the decoder 107 may also perform packet washing to reduce unwanted ancillary chunks prior to reordering the LEND chunk(s).

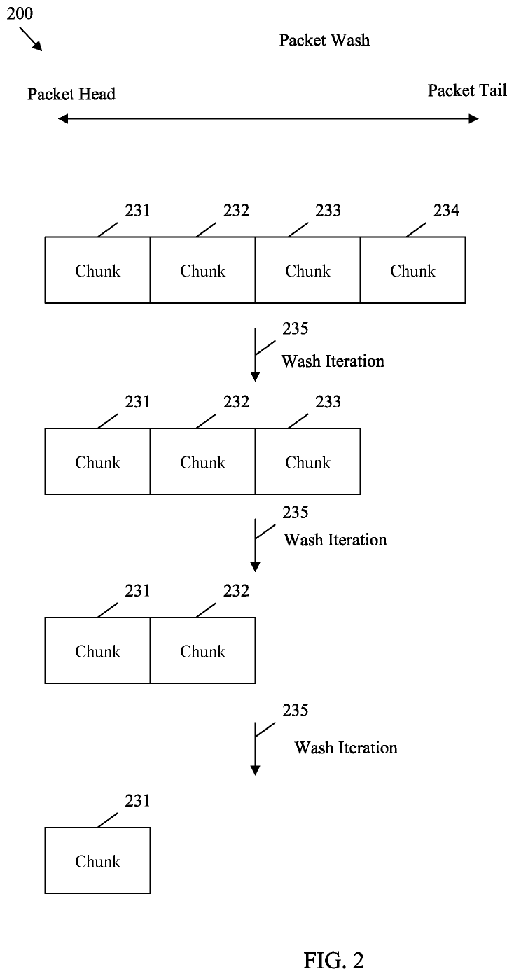

FIG. 2 illustrates an example mechanism of performing a packet wash 200 to support qualitative communication. Packet wash 200 may be employed by a network node, such as transit node 105 and/or a decoder 107 in network 100. Packet wash 200 is applied to a packet, such as an image data packet 111, which may include chunk 231, chunk 232, chunk 233, and chunk 234. The chunks 231-234 contain data arranged in order of decreasing priority with highest priority chunks toward the front/head of the packet and lowest priority chunks toward the end/tail of the packet. When congestion occurs, packet wash 200 begins to incrementally drop chunks from the end of the packet unit the packet is smaller than a current bandwidth and/or memory availability. The packet can then be transmitted using the bandwidth availability. Bandwidth availability may include a measurement of memory available to store the packet until the packet can be transmitted, a measurement of transmitter resources available to transmit the packet, a measurement of link availability to carry the packet from the node, the same for other packets, or combinations thereof.

For example, the packet wash 200 can perform a wash iteration 235 by dropping the lowest priority chunk 234 from the end of the packet payload. In the event that the packet is still too large to be stored/transmitted, the packet wash 200 can perform another wash iteration 235 by dropping the lowest priority chunk 233 from the end of the packet payload. In the event that the packet is still too large to be stored/transmitted, the packet wash 200 can perform another wash iteration 235 by dropping the lowest priority chunk 232 from the end of the packet payload. In the event that a packet containing a single chunk 231 cannot be transmitted, the packet can be entirely dropped. Further, the packet can contain metadata indicating a minimum acceptable quality for the packet. The entire packet can also be dropped when dropping a chunk 232-234 would reduce the quality of the packet below the minimum acceptable quality. By arranging chunks according to a designation of critical or ancillary instead of arranging chunks according to ordering constraints 400, image data can be arranged in order of priority so that packet wash 200 can be applied to an image data packet.

FIG. 3 is a schematic diagram illustrating an example of an interlacing mechanism for coding an image 300, such as a PNG image, as multiple layers of reduced images. For example, image 300 can be coded by an encoder 101 and/or a content server 103, included in image data packets 111, and transmitted to a decoder 107 in network 100. Further, data describing the image 300 can be ordered into packet(s) so that a packet wash 200 can be applied to the corresponding packet(s).

The image 300 includes a plurality of pixels. Each pixel is depicted as a numbered box. For example, each pixel may include a red, green, and a blue value. In the present example, the depicted box includes a single value. Hence, the mechanism for coding the image may be applied three times for an image such as image 300 (e.g., once for red values, once for green values, and once for blue values). The mechanism is applied to each eight by eight block of pixels. The image 300 is depicted as including four of such blocks for clarity of discussion, but in practical applications an image may include a different number of blocks (e.g., eight blocks, sixteen blocks, etc.) with different dimensions (e.g., four by four, sixteen by sixteen, etc.).

The interlacing mechanism, which may be known as Adam7, converts the image 300 into seven reduced images, denoted herein as reduced image 301, reduced image 302, reduced image 303, reduced image 304, reduced image 305, reduced image 306, and reduced image 307. Each reduced image and any associated metadata may be referred to as an image layer. The reduced image 301 contains boxes that are denoted as including the number one to indicate an association with layer one. In practice, such boxes would contain a color value. The reduced image 301 contains boxes taken from image 300 that also contain the value one. Specifically, the reduced image 301 contains the value of the top left pixel of each eight by eight block of pixels.

Reduced images 302, 303, 304, 305, 306, and 307 contain boxes that are denoted as including the numbers two, three, four, five, six, and seven, respectively, and are similar to reduced image 301. Specifically, reduced image 302 includes the value of the pixel in the fifth position from the left in the top row of the eight by eight block in image 300. Further, reduced image 303 includes two pixels taken from the first and fifth position in the fifth row from the top of the eight by eight block in image 300. Reduced image 304 includes four pixels taken from the third and seventh positions in the first row and the fifth row from the top of the eight by eight block in image 300. Reduced image 305 includes eight pixels taken from the first, third, fifth, and seventh positions in the third row and the seventh row from the top of the eight by eight block in image 300. Reduced image 306 includes sixteen pixels taken from the second, fourth, sixth, and eighth positions in the first, third, fifth, and seventh rows from the top of the eight by eight block in image 300. Reduced image 307 includes thirty-two pixels taken from the entire second, fourth, sixth, and eight rows from the top of the eight by eight block in image 300.

As can be seen in FIG. 3, reduced images 301-307 include all of the pixel values from image 300. As such, reduced images 301-307 can be combined by a decoder to recreate image 300. However, the pixels from the reduced images 301-307 are positioned so that various layers can be omitted when recreating image 300. When a reduced image 301-307 is not received at a decoder, the corresponding pixels are not represented. As the pixels in each reduced image 301-307 are spread across the image 300, the loss of any one reduced image 301-307 degrades the quality of the image 300 while still providing a reasonable approximation of the original image. As additional reduced images 301-307 are lost, the quality of the image degrades further. It should also be noted that the decoder can render the reduced images 301-307 as they are received. In this way, a degraded version of image 300 can be quickly displayed. The image 300 can then be displayed in better quality as more reduced images 301-307 are received and corresponding pixel values are filled in.

FIG. 4 is a schematic diagram illustrating an example of ordering constraints 400 in PNG files. Specifically, PNG files, which contain an image such as image 300, may be required to comply with ordering constraints 400 due to corresponding PNG coding standards. For example, such standards may require a PNG file be formatted in a particular way at an encoder, such as an encoder 101 and/or content server 103, so that any decoder, such as decoder 107, that complies with the standard can consistently decode the PNG file. In the present disclosure, encoding software at the encoder may encode a PNG file according to constraints 400. The transmission source (e.g., the encoder and/or content server) can then reorder the chunks of the PNG file prior to transmission to support packet wash 200. The destination (e.g., the decoder) can then reorder the PNG chunks according to ordering constraints 400 upon receipt prior to sending the PNG file to decoding software. In this way, the encoding software and the decoding software need not be modified in a manner that would place such software systems outside of compliance with the PNG standards that include the ordering constraints 400.

A PNG file, or a layer thereof, may include many different types of chunks, and such chunks are ordered according to ordering constraints 400 during encoding and prior to decoding (e.g., changes made to support packet washing notwithstanding). It should also be noted that the depicted chunks include commonly used chunks. However, the chunks shown with respect to ordering constraints 400 should not be considered as exhaustive. Further, any chunks that are ancillary should be considered optional. In addition, the depicted chunks may be employed multiple times in the same PNG file, or in layer thereof. The first chunk in a layer of a PNG file is an image header (IHDR) chunk 411. The IHDR chunk 411 indicates the image width, height, bit depth, color type, compression method, filter method, interlace method, and/or other similar data. The IHDR chunk 411 may be required to be the first chunk in a PNG file and may be considered as a critical chunk. The last chunk in a layer of the PNG file is the IEND chunk 413. The IEND chunk 413 marks the end of the image and may include an empty data field. The IEND chunk 413 may be considered to be a critical chunk. The other chunks in a layer of the PNG file are positioned between the IHDR chunk 411 and the IEND chunk 413.

A layer of a PNG file may include a time changed (tIME) chunk 434, a compressed text (zTXt) chunk 433, a text (tEXt) chunk 432, and a text keywork (iTXt) chunk 431. The tIME chunk 434, tEXt chunk 432, zTXt chunk 433, and iTXt chunk 431 can be positioned anywhere between the IHDR chunk 411 and the IEND chunk 413 and may all be considered ancillary chunks. The tIME chunk 434 indicates a time indicating when the image was last changed. The tEXt chunk 432 indicates text related to the image. The zTXt chunk 433 indicates compressed text related to the image. The iTXt chunk 431 contains a keyword and/or text indicating encodings used for compression and/or translation.

A layer of a PNG file may also include a palette table (PLTE) chunk 415, a standard red green blue (sRGB) chunk 435, a default background (bKGD) chunk 436, a chromaticity (cHRM) chunk 437, a transparency information (tRNS) chunk 438, a gamma value (gAMA) chunk 439, a significant bits (sBIT) chunk 440, an intended pixel size (pHYs) chunk 441, a suggested palette (sPLT) chunk 442, and an international color consortium (iCCP) chunk 443. The PLTE chunk 415 may be considered to be a critical chunk. The sRGB chunk 435, bKGD chunk 436, cHRM chunk 437, tRNS chunk 438, gAMA chunk 439, sBIT chunk 440, pHYs chunk 441, sPLT chunk 442, and iCCP chunk 443 may all be considered to be ancillary chunks. The PLTE chunk 415, sRGB chunk 435, bKGD chunk 436, cHRM chunk 437, tRNS chunk 438, gAMA chunk 439, sBIT chunk 440, pHYs chunk 441, sPLT chunk 442, and iCCP chunk 443 should all be positioned after the IHDR chunk 411 and before any IDAT chunks 420, and hence before the IEND chunk 413.

The PLTE chunk 415 contains a palette for the image, where the palette is a list of colors/color values present in the image. The sRGB chunk 435 indicates whether the standard red, green, blue (RGB) color space is used. The bKGD chunk 436 indicates a default background color for the image. The cHRM chunk 437 indicates chromaticity coordinates of display primaries as well as a white point. The tRNS chunk 438 indicates transparency information, such as alpha channel values for pallet entries and/or pixel values that should be regarded as fully transparent. The gAMA chunk 439 contains a gamma value to support gamma correction. The sBIT chunk 440 contains data indicating a color accuracy of the source data. The pHYs chunk 441 indicates an intended pixel size and/or a pixel aspect ratio. The sPLT chunk 442 suggests a pallete for use when the full range of colors used in the image is unavailable at the decoder. The iCCP chunk 443 contains an international color consortium (ICC) color profile.

A layer of a PNG file may also include IDAT chunks 420. An IDAT chunk 420 contains image data, such as red, green, or blue pixel values taken from a reduced image. For example, a first layer of the PNG file contains IDAT chunks 420 representing a first reduced image 301, a second layer of the PNG file contains IDAT chunks 420 representing a second reduced image 302, etc. IDAT chunks 420 are positioned before the LEND chunk 413 and after the IHDR chunk 411, PLTE chunk 415, sRGB chunk 435, bKGD chunk 436, cHRM chunk 437, tRNS chunk 438, gAMA chunk 439, sBIT chunk 440, pHYs chunk 441, sPLT chunk 442, and iCCP chunk 443. Ordering constraints may consider IDAT chunks 420 to all be critical chunks. However, in some examples the encoder may determine to redesignate IDAT chunks 420 corresponding to specific layers as ancillary to support packet washing. It should be noted that PNG standards may define IDAT chunks as critical chunks. However, for purposes of the present disclosure, IDAT chunks may be designated as critical chunks or ancillary chunks, depending on the embodiment.

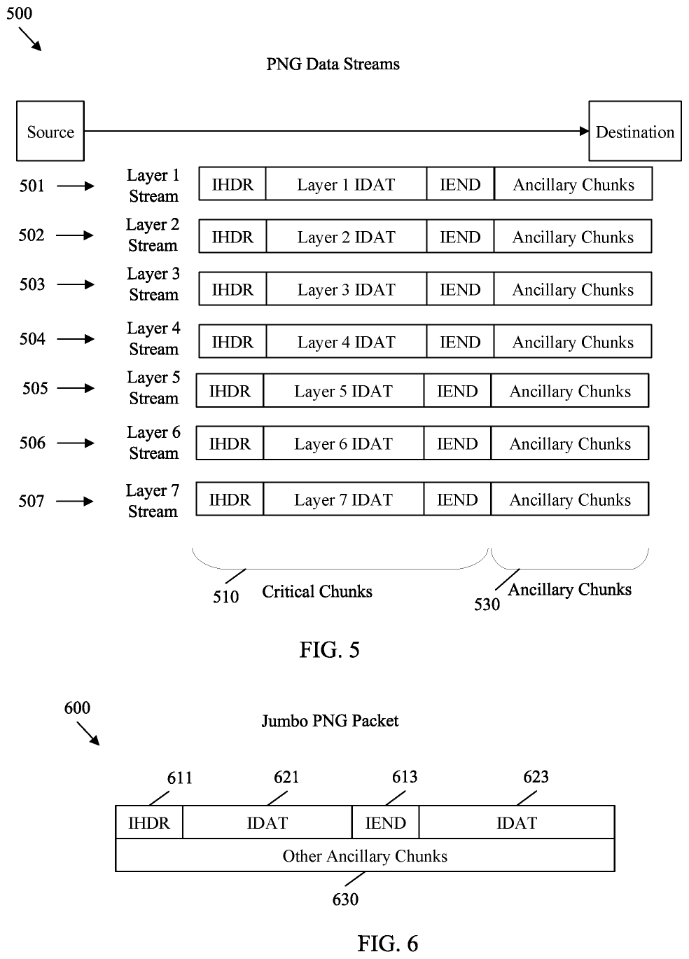

FIG. 5 is a schematic diagram illustrating an example mechanism for arranging interlaced image data into multi-layer streams 500 that support a packet wash. A stream is a group of one or more packets that are part of a communication session. In the present example, the multi-layer streams 500 are separated so that each layer of an interlaced image is transmitted in a separate stream. For example, a PNG file, such as image 300, may be sorted into a plurality (e.g., seven) of data streams. These streams may be transmitted between a source, such as encoder 101 and/or content server 103, and a destination, such as decoder 107. In the present example, the source has reordered the multi-layer streams 500 from an order that complies with the ordering constraints 400. Instead, the chunks have been ordered to position the critical chunks 510 toward the beginning of the corresponding stream, and hence the head of corresponding packet(s) and position the ancillary chunks 530 toward the end of the corresponding stream, and hence the tail of corresponding packet(s). This ordering supports application of packet wash 200 to the packets in the streams during transit between the source and the destination.

For example, the multi-layer streams 500 may include a layer 1 stream 501, a layer 2 stream 502, a layer 3 stream 503, a layer 4 stream 504, a layer 5 stream 505, a layer 6 stream 506, and a layer 7 stream 507, which include a reduced image 301, a reduced image 302, a reduced image 303, a reduced image 304, a reduced image 305, a reduced image 306, and a reduced image 307, respectively, along with associated metadata (e.g., ancillary chunks as described with respect to FIG. 4). As shown, the critical chunks 510 are ordered so that the IHDR chunk is positioned first, the LEND chunk is positioned last, and other critical chunks, such as IDAT chunks carrying layer specific image data, are positioned between the IHDR chunk and the LEND chunk. All chunks that are designated as ancillary chunks 530 are positioned after the LEND chunk. In this way, the packet wash can begin by dropping ancillary chunks 530 from the end of the stream and hence from the tail of the corresponding packet(s). The washing may continue until the LEND chunk is reached. In this way, the ancillary chunks 530 are dropped when needed to overcome congestion, while the critical chunks 510 are maintained.

It should be noted that designation of critical versus ancillary may be made by the source, for example based on parameters received from the destination as part of a request for the image file. For example, one or more layers of IDAT chunks may be designated as ancillary chunks 530 in some cases. This has the effect of potentially degrading the quality of the reconstructed image at the destination. Designating metadata as ancillary chunks 530 has the potential for degrading functionality of the reconstructed image at the destination. Accordingly, when the user at the destination indicates a particular functionality is important to the user, the corresponding data can be designated as a critical chunk. Regardless of the example, designating data as ancillary and positioning corresponding ancillary chunks 530 at the end of the stream/packet allows such data to be selectively dropped by the network without requiring that the entire packet be resent. This reduces network congestion and increases the speed at which the user is allowed to see portions of the image contained in the critical chunks 510.

In some examples, the destination may also perform a packet wash on the ancillary chunks 530 to remove metadata that the destination does not plan to use. Regardless of the example, the destination may reorder the multi-layer streams 500 according to ordering constraints 400 prior to sending the resulting data to decoder software. This ensures that the decoder software remains compliant with corresponding standards.

FIG. 6 is a schematic diagram illustrating an example mechanism for arranging interlaced image data into a single jumbo packet 600 that supports a packet wash, such as packet wash 200. For example, the jumbo packet 600 may be configured to contain an entire PNG image, such as image 300. Accordingly, the jumbo packet 600 may contain substantially the same data as all of the multi-layer streams 500. Accordingly, a source, such as encoder 101 and/or content server 103, can generate and transmit the jumbo packet 600 via transit nodes 105 to a destination, such as a decoder 107. The source can reorder the data in the jumbo packet 600 from an order specified by ordering constraints 400 to support application of a packet wash. The destination can then perform a packet wash, if desired, and reorder the data in the jumbo packet 600 to comply with the ordering constraints 400 prior to decoding.

The jumbo packet 600 may contain an IHDR chunk 611, IDAT chunks 621, an LEND chunk 613, IDAT chunks 623, and other ancillary chunks 630 in descending priority order. The IHDR chunk 611 and the LEND chunk 613 may be substantially similar to the IHDR chunk 411 and the LEND chunk 413, respectively. However, unlike in the multi-layer streams 500, the jumbo packet 600 may only include one IHDR chunk 611 and one LEND chunk 613. The IDAT chunks 621 and 623 contain reduced images, such as reduced images 301-307. As noted above, a source can determine to set some layers as critical and some layers as ancillary. The IDAT chunks 621 are positioned before the LEND chunk 613, and therefore all of the chunks containing image data from the layers that are designated as critical are included in IDAT chunks 621. Further, the chunks that contain image data from the layers that are designated as ancillary are included in IDAT chunks 623. All other metadata, such as iTXt 431 through iCCP 443 as depicted in FIG. 4 can be included in the other ancillary chunks 630. In an example, each of the layers that are included in the IDAT chunks 623 can be designated with a priority. The IDAT chunks 623 can then be arranged in order of priority. Further, the other ancillary chunks 630 can be designated with a priority and then arranged in order of priority. In this way, packet washing can begin dropping chunks from the tail of the packet, which contains the lowest priority of the ancillary chunks 630. Accordingly, all of the ancillary metadata is dropped before any image data is dropped. When desired, the packet wash can proceed to dropping the IDAT chunks 623 from lowest priority to highest priority. The packet wash stops when the LEND chunk 613 is reached. If further washing is needed, then the jumbo packet 600 can be dropped.

As with the multi-layer streams 500, the data in the jumbo packet 600 can be designated as critical or ancillary at the source, for example based on predefined rules and/or based on parameters from the destination. Critical chunks are positioned before the LEND chunk 613 and ancillary chunks are positioned after the LEND chunk. Designating data as ancillary and positioning corresponding ancillary chunks at the end of the jumbo packet 600 allows such data to be selectively dropped by the network without requiring that the entire packet be resent. This reduces network congestion. In some examples, the destination may also perform a packet wash on the ancillary chunks to remove metadata that the destination does not plan to use. Regardless of the example, the destination may reorder the data in the jumbo packet 600 according to ordering constraints 400 prior to sending the resulting data to decoder software. This ensures that the decoder software remains compliant with corresponding standards.

In an example, the jumbo packet 600 can be implemented by using a so-called New IP packet paradigm. In a New IP packet, the IHDR chunk 611, IDAT chunks 621, LEND chunk 613, IDAT chunks 623, and other ancillary chunks 630 are included in a packet payload. A New IP packet can have a variable size, and hence can support the entire PNG file. A New IP packet also includes a packet header. The packet header includes a header specification at the start of the packet header. The header specification describes the offsets to specifications for shipping, contract, and payload components, respectively. The New IP header includes a shipping specification that includes a variable length set of addresses. The New IP header also includes a contract specification that indicates how the packet and/or an associated flow should be treated by network nodes handling the packet. The network and routers fulfill the contract, assuming the contract has been agreed between the packet sender/receiver and the network. For example, the contract may be composed of multiple contract clauses, each of which is a combination of event, condition, action, and metadata. A contract clause describes how the routers treat the packet as the packet traverses the network based on a predefined triggering event and condition. The metadata contains data related to the packet, e.g. accounting information, customized statistics regarding the flow on intermediate hops, contextual information related to the user, contextual information related to the application, etc. In-network node intelligence is naturally embedded and supported by the New IP framework. The New IP payload specification associates semantics to the data payload, and hence can include the jumbo packet 600. The New IP payload is configured to support qualitative communication/packet washing.

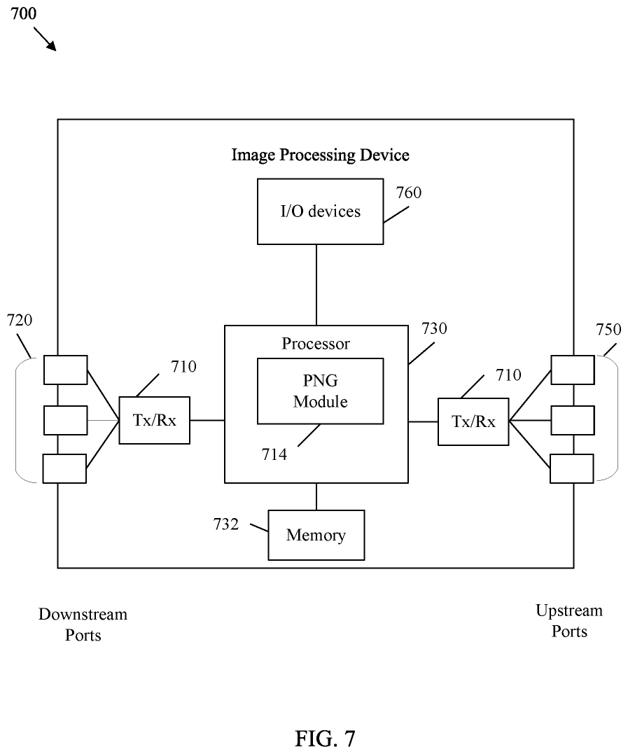

FIG. 7 is a schematic diagram of an example image processing device 700. The image processing device 700 is suitable for implementing the disclosed examples/embodiments as described herein. The image processing device 700 comprises downstream ports 720, upstream ports 750, and/or transceiver units (Tx/Rx) 710, including transmitters and/or receivers for communicating data upstream and/or downstream over a network. The image processing device 700 also includes a processor 730 including a logic unit and/or central processing unit (CPU) to process the data and a memory 732 for storing the data. The image processing device 700 may also comprise electrical, optical-to-electrical (OE) components, electrical-to-optical (EO) components, and/or wireless communication components coupled to the upstream ports 750 and/or downstream ports 720 for communication of data via electrical, optical, or wireless communication networks. The image processing device 700 may also include input and/or output (I/O) devices 760 for communicating data to and from a user. The I/O devices 760 may include output devices such as a display for displaying image and/or video data. The I/O devices 760 may also include input devices, such as a keyboard, mouse, trackball, etc., and/or corresponding interfaces for interacting with such output devices.

The processor 730 is implemented by hardware and software. The processor 730 may be implemented as one or more CPU chips, cores (e.g., as a multi-core processor), field-programmable gate arrays (FPGAs), application specific integrated circuits (ASICs), and digital signal processors (DSPs). The processor 730 is in communication with the downstream ports 720, Tx/Rx 710, upstream ports 750, and memory 732. The processor 730 comprises a PNG module 714. The PNG module 714 implements the disclosed embodiments described herein, such as packet wash 200 and/or method 800, 900, and/or 1000, which may employ an image 300, ordering constraints 400, multi-layer streams 500 and/or a jumbo packet 600. The PNG module 714 may also implement any other method/mechanism described herein. Further, the PNG module 714 may implement functionality in a device in network 100, such as an encoder 101, a content server 103, a transit node 105, and/or a decoder 107. Further, the PNG module 714 may implement a device in system 1100. For example, when operating on an encoder the PNG module 714 may designate interlaced image chunks as ancillary or critical and position such chunks into one or more image data packets in an order based on such designations. When operating on a transit node, the PNG module 714 may perform a packet wash on an image data packet from tail toward head and stop the wash based on the position of an LEND chunk. When operating on a decoder, the PNG module 714 may receive image data packets, reorder chunks from priority order as desired to comply with constraints, and decode the image data for display. Accordingly, the PNG module 714 may be configured to perform mechanisms to address one or more of the problems discussed above. Hence, PNG module 714 causes the image processing device 700 to provide additional functionality when coding, handling, and/or decoding image data. As such, the PNG module 714 improves the functionality of the image processing device 700 as well as addresses problems that are specific to the image coding arts. Further, the PNG module 714 affects a transformation of the image processing device 700 to a different state. Alternatively, the PNG module 714 can be implemented as instructions stored in the memory 732 and executed by the processor 730 (e.g., as a computer program product stored on a non-transitory medium).

The memory 732 comprises one or more memory types such as disks, tape drives, solid-state drives, read only memory (ROM), random access memory (RAM), flash memory, ternary content-addressable memory (TCAM), static random-access memory (SRAM), etc. The memory 732 may be used as an over-flow data storage device, to store programs when such programs are selected for execution, and to store instructions and data that are read during program execution.

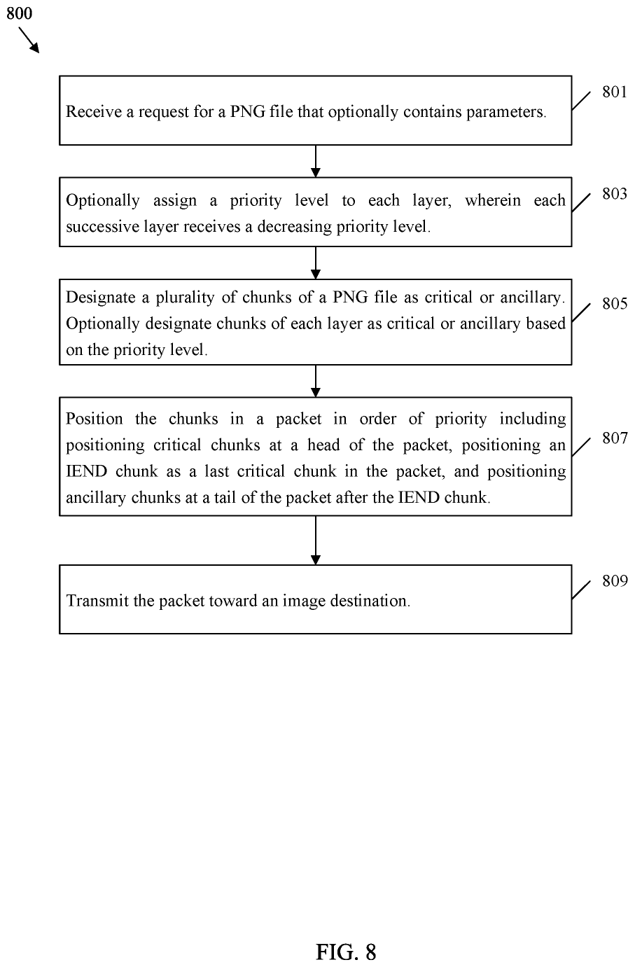

FIG. 8 is a flowchart of an example method 800 of ordering interlaced image data, such as an image 300, to support packet washing, for example according to packet wash 200, as part of qualitative communication, for example in network 100. For example, the method 800 may be implemented by an encoder 101, a content server 103, and/or an image processing device 700. The method 800 may result in the implementation of method 900 at a transit node and/or method 1000 at an image destination. For example, the method 900 may obtain an image file that complies with ordering constraints 400 and reorder the image file to generate multi-layer streams 500 and/or a jumbo packet 600 for transmission toward a destination.

Method 800 may be initialized when an image source determines to prepare to transmit image data of an image, such as a PNG. At step 801, the image source receives a request for the PNG file. The request may optionally contain parameters indicating a relative importance of image quality to the end user and/or indicating the relative importance of specified metadata to the end user. In some examples, the parameters in the request indicate an image smoothness requirement of an image destination, an image attribute preference of the image destination, a decoding capability of the image destination, or combinations thereof. The image smoothness requirement may indicate which layers are needed to meet the user's expectations and hence which layers are critical. The attribute preference may indicate which metadata the user expects, and hence which metadata is critical versus ancillary. The decoding capability may indicate which metadata the destination is capable of using, and hence unusable metadata can be designated as ancillary.

At step 803, image source may optionally assign a priority level to each layer of the PNG file. As noted above, a layer of a PNG file contains a reduced image that contains a portion of an original image. In an example, each successive layer may receive a decreasing priority level. Further, the metadata related to the PNG file may also receive a priority level. In an example, the priority level of the metadata may be less than the priority levels of the layers of the image. The priority levels of the layers and/or metadata may be assigned based on predetermined rules and/or base on the parameters in the request from step 801.

At step 805, the image source designates each of a plurality of chunks of a PNG file as critical or ancillary (e.g., based on priority level assigned in step 803). In an example, the metadata chunks and/or the chunks of each layer may be designated as critical or ancillary based on the priority level of each layer and/or chunk as assigned in step 803. In some examples, the critical chunks include an IHDR chunk, a PLTE chunk, IDAT chunks, an IEND chunk, or combinations thereof. In some examples, the ancillary chunks include a tRNS chunk, a cHRM chunk, a gAMA chunk, an iCCP chunk, a sBIT chunk, a sRGB chunk, an iTXt chunk, a tEXt chunk, a zTXt chunk, a bKGD chunk, a hIST chunk, a pHYs chunk, a sPLT chunk, a tIME chunk, selected IDAT chunks, or combinations thereof.

At step 807, the image source may position the chunks in a packet, or a stream of packets, in order of priority. This includes positioning the chunks in a packet in a distinct order according to a priority of the chunks and their designation as critical or ancillary. For example, this may include critical chunks at a head of the packet, positioning an IEND chunk as a last critical chunk in the packet, and positioning ancillary chunks at a tail of the packet after the IEND chunk. As the IEND chunk is the last critical chunk, the IEND chunk indicates a threshold beyond which no packet wash can be applied when proceeding from the tail of the packet to the head of the packet. Accordingly, the IEND chunk is not positioned as a last chunk in the packet. The ancillary chunks may also be positioned in an order of descending priority. The chunks are positioned to support ancillary chunk removal by a packet wash process during packet transit (e.g., from the tail of the packet toward the head of the packet). As noted above, the image data chunks (e.g., the IDAT chunks) may be associated with seven layers of the PNG file. In some examples, each layer of the PNG file can be positioned into a different stream of packets. In other examples, the packet is a jumbo packet that includes the entire PNG file including all of the layers and corresponding IDAT chunks for the image. In some examples, the image source may also position a second IEND chunk as a last chunk in the packet in order to indicate the actual end of the packet payload. In some examples, all critical chunks of a layer are positioned before all ancillary chunks of the layer. In some examples, a chunk of a lower priority layer is positioned before an ancillary chunk of a higher priority layer.

At step 809, the image source transmits the packet toward an image destination.

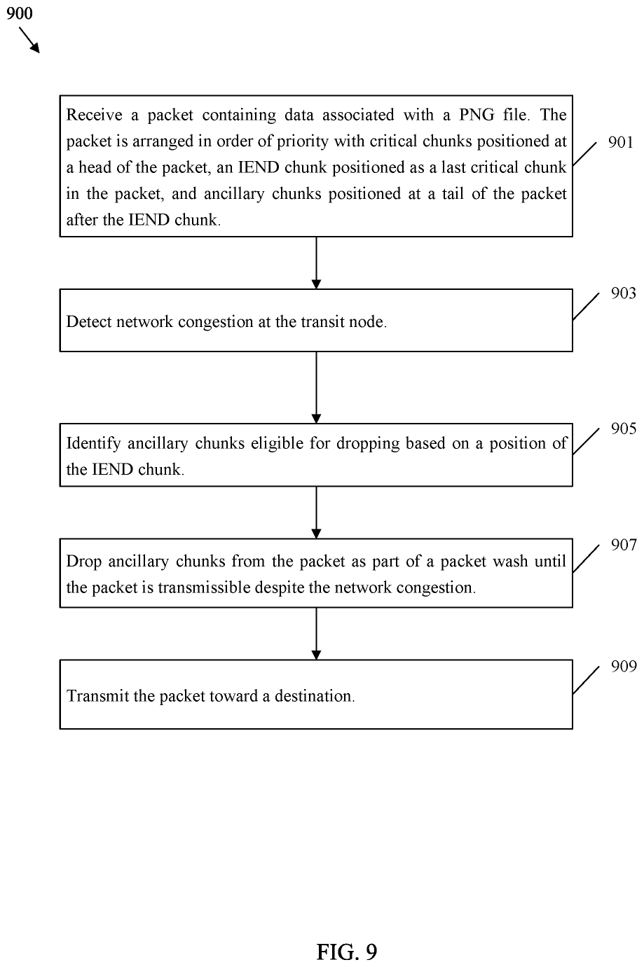

FIG. 9 is a flowchart of an example method 900 of performing a packet wash, for example according to packet wash 200, of interlaced image data, such as an image 300. For example, the method 900 may be implemented by a transit node 105 and/or an image processing device 700. The method 900 can be employed in response to method 800 and may result in the implementation of method 1000 at an image destination. For example, the method 1000 may receive, handle, and transmit a PNG file as multi-layer streams 500 and/or a jumbo packet 600, which may be reordered from an encoding that complies with ordering constraints 400.

Method 900 may begin when a transit node receives an image data packet from an image source, optionally via one or more other transit nodes. At step 901, the transit node receives a packet containing data associated with a PNG file. The packet is arranged in a distinct order according to a priority of the chunks and their designation as critical or ancillary. For example, the chunks may be positioned in order of priority with critical chunks positioned at a head of the packet, an LEND chunk positioned as a last critical chunk in the packet, and ancillary chunks positioned at a tail of the packet after the LEND chunk. As the LEND chunk is the last critical chunk, the LEND chunk indicates a threshold beyond which no packet wash can be applied when proceeding from the tail of the packet to the head of the packet. Accordingly, the LEND chunk is not positioned as a last chunk in the packet. In some examples, the packet corresponds to a stream of packets associated with one layer of the PNG file. In other examples, the packet is a jumbo packet that includes the entire PNG file. In some examples, all critical chunks of a layer are positioned before all ancillary chunks of the layer. In some examples, a chunk of a lower priority layer is positioned before an ancillary chunk of a higher priority layer.

At step 903, the transit node detects network congestion, for example due to low memory for storing packets, low available bandwidth for re-transmitting the packet, etc. At step 905, the transit node identifies ancillary chunks eligible for dropping based on a position of the LEND chunk. Such identification can be performed in response to detection of the network congestion at step 903.

At step 907, the transit node drops ancillary chunks from the packet as part of a packet wash until the packet is transmissible despite the network congestion. The ancillary chunks are dropped starting at the tail of the packet and progressing toward the head of the packet. The transit node may not drop the IEND chunk or any chunk positioned before the IEND chunk. When dropping the IEND chunk would be required to overcome the congestion, the transit node may drop the packet. In some examples, the critical chunks include an IHDR chunk, a PLTE chunk, IDAT chunks, an LEND chunk, or combinations thereof. In some examples, the ancillary chunks include a tRNS chunk, a cHRM chunk, a gAMA chunk, an iCCP chunk, a sBIT chunk, a sRGB chunk, an iTXt chunk, a tEXt chunk, a zTXt chunk, a bKGD chunk, a hIST chunk, a pHYs chunk, a sPLT chunk, a tIME chunk, selected IDAT chunks, or combinations thereof. As noted above, the PNG file includes a plurality of layers. In some examples, some of the reduced images/layers of the PNG file may be designated as ancillary. In such a case, the IDAT chunks that contain data corresponding to the ancillary layers are ancillary. Accordingly, the packet may include at least one chunk in the packet contains image data of a layer designated as ancillary. In such a case, any IDAT chunks positioned after the LEND chunk can be dropped at step 907. In some examples, a second LEND chunk can be positioned as a last chunk in the packet in order to indicate the actual end of the packet payload. In such a case, the second LEND chunk is dropped first by a packet wash at step 907.

At step 909, the transit node transmits the packet toward a destination.

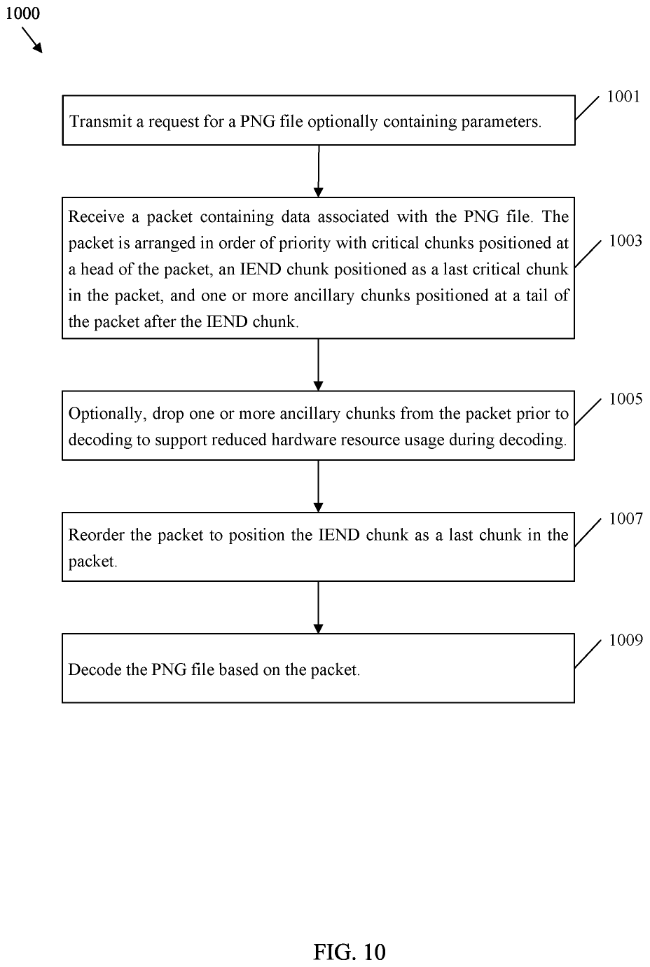

FIG. 10 is a flowchart of an example method 1000 of decoding interlaced image data, such as an image 300, from an order supporting packet washing, for example according to packet wash 200, as part of qualitative communication, for example in network 100. For example, the method 1000 may be implemented by a decoder 107 and/or an image processing device 700. The method 1000 can be employed in response to methods 800 and/or 900. For example, the method 1000 may receive a PNG file as multi-layer streams 500 and/or a jumbo packet 600. The method 1000 may also reorder the received data to comply with ordering constraints 400.

Method 1000 may begin when an image destination requests an interlaced image file, such as a PNG file. At step 1001, the image destination transmits a request for the PNG file to an image source. This occurs prior to receiving the PNG file at step 1003. The request may optionally contain parameters to indicate an image smoothness requirement, an image attribute preference, a decoding capability, or combinations thereof. The source may determine whether chunks of the PNG file are critical or ancillary based on such parameters.

At step 1003, the image destination receives a packet containing data associated with a PNG file. The packet is arranged in a distinct order according to a priority of the chunks and their designation as critical or ancillary. For example, the chunks may be positioned in order of priority with critical chunks positioned at a head of the packet, an LEND chunk positioned as a last critical chunk in the packet, and ancillary chunks, if any, positioned at a tail of the packet after the IEND chunk. As the LEND chunk is the last critical chunk, the position of the LEND chunk indicates a threshold beyond which no packet wash can be applied when proceeding from the tail of the packet to the head of the packet. Accordingly, the IEND chunk is not positioned as a last chunk in the packet unless, of course, all ancillary chunks were washed away (e.g., as a result of method 900). In some examples, the packet corresponds to a stream of packets associated with one layer of the PNG file. In other examples, the packet is a jumbo packet that includes the entire PNG file. In some examples, the packet, as received, has lost one or more ancillary chunks during transit to a packet wash operation in a network, for example at a transit node according to method 900. In some examples, the critical chunks include an IHDR chunk, a PLTE chunk, IDAT chunks, an LEND chunk, or combinations thereof. In some examples, the ancillary chunks include a tRNS chunk, a cHRM chunk, a gAMA chunk, an iCCP chunk, a sBIT chunk, a sRGB chunk, an iTXt chunk, a tEXt chunk, a zTXt chunk, a bKGD chunk, a hIST chunk, a pHYs chunk, a sPLT chunk, a tIME chunk, selected IDAT chunks, or combinations thereof. As noted above, the PNG file includes a plurality of layers. In some examples, some of the reduced images/layers of the PNG file may be designated as ancillary. In such a case, the IDAT chunks that contain data corresponding to the ancillary layers are ancillary. Accordingly, the packet may include at least one chunk in the packet contains image data of a layer that is designated as ancillary. In some examples, all critical chunks of a layer are positioned before all ancillary chunks of the layer. In some examples, a chunk of a lower priority layer is positioned before an ancillary chunk of a higher priority layer.

At step 1005, the image destination may optionally drop one or more ancillary chunks from the packet prior to decoding to support reduced hardware resource usage during decoding. For example, the image destination may be operating on limited power and/or limited hardware availability and may not wish to use the full functionality corresponding to the metadata. In such a case, the image destination may perform a wash and drop all ancillary chunks to avoid further processing overhead related to such chunks.

At step 1007, the image destination reorders the packet to position the LEND chunk as a last chunk in the packet (assuming the LEND chunk is not already the last chunk), for example to comply with ordering constraints 400. In some examples, reordering may include positioning one or more ancillary chunks prior to chunks containing image data. Further, reordering may include positioning ancillary chunks prior to the IEND chunk.

At step 1009, the image destination sends the reordered PNG data to a decoder. The decoder can then decode the PNG file based on the packet.

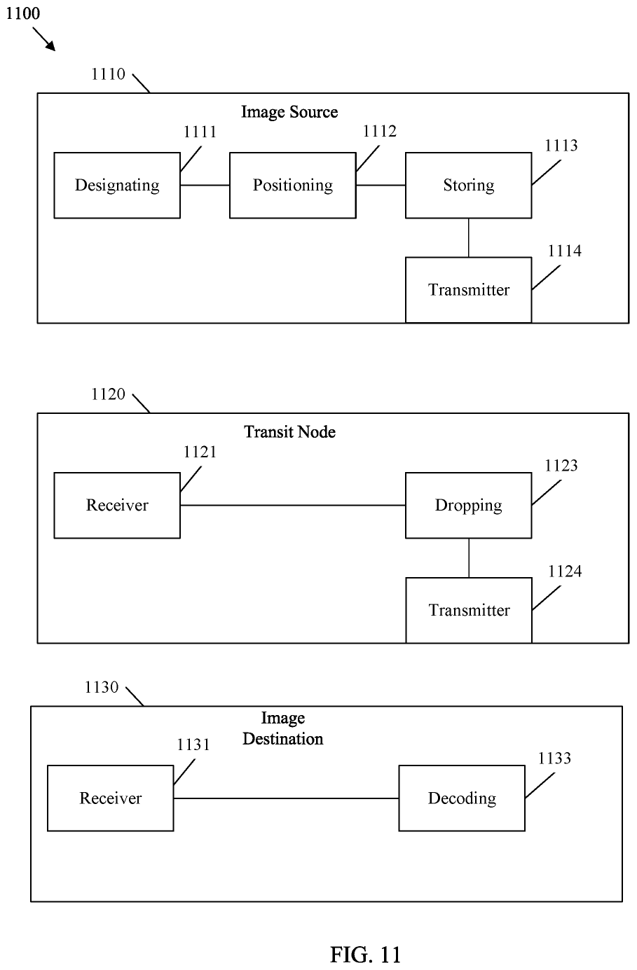

FIG. 11 is a schematic diagram of an example system 1100 for ordering interlaced image data, such as an image 300, to support packet washing, for example according to packet wash 200, as part of qualitative communication, for example in network 100. The system 1100 may be implemented on an encoder 101, a content server 103, a transit node 105, a decoder 107 and/or an image processing device 700. For example, the system 1100 can manage ordering constraints 400 when transmitting multi-layer streams 500 and/or jumbo packet 600.

The system 1100 includes an image source 1110, such as an encoder 101 and/or a content server 103. The image source 1110 comprises a designating module 1111 for designating a plurality of chunks of an interlaced image file, such as a PNG file, according as critical or ancillary. The image source 1110 further comprises a positioning module 1112 for positioning the chunks in a packet in a distinct order according to a priority of the chunks and their designation as critical or ancillary. The image source 1110 further comprises a storing module 1113 for storing the packet. The image source 1110 further comprises a transmitter 1114 for transmitting the packet toward an image destination. The image source 1110 may be further configured to perform any of the steps of method 800.

The system 1100 further includes a transit node 1120, such as a transit node 105. The transit node 1120 comprises a receiver module 1121 for receiving a packet containing data associated with an interlaced image file, such as a PNG file, wherein the packet is arranged in order of priority with critical chunks positioned at a head of the packet, an LEND chunk positioned as a last critical chunk in the packet, and ancillary chunks positioned at a tail of the packet after the LEND chunk. The transit node 1120 further comprises a dropping module 1123 for dropping ancillary chunks from the packet as part of a packet wash until the packet is transmissible despite the network congestion. The transit node 1120 further comprises a transmitter 1124 for transmitting the packet toward an image destination. The transit node 1120 may be further configured to perform any of the steps of method 900.

The system 1100 further includes an image destination 1130, such as a decoder 107. The image destination 1130 comprises a receiver module 1131 for receiving a packet containing data associated with an interlaced image file, such as a PNG file, wherein chunks of the packet are arranged in a distinct order according to a priority of the chunks and their designation as critical or ancillary. The image destination 1130 further comprises a decoding module 1133 for decoding the PNG file based on the packet. The image destination 1130 may be further configured to perform any of the steps of method 1000. The image source 1110, the transit node 1120, and the image destination 1130 are operatively coupled to each other in a manner sufficient to facilitate the embodiments disclosed herein.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

It should also be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other examples of changes, substitutions, and alterations are ascertainable by one skilled in the art and may be made without departing from the spirit and scope disclosed herein.

What is claimed is:

1. A method implemented by an image source, the method comprising:
designating, by one or more processors of the image source, each chunk of a plurality of chunks of an interlaced image file as critical or ancillary;
positioning, by the one or more processors, the chunks in a packet in a priority order according to a priority of the chunks and their designation as critical or ancillary; and
transmitting, by a transmitter of the image source, the packet toward an image destination.

2. The method of claim 1, wherein positioning the chunks comprises positioning critical chunks at a head of the packet, positioning an image trailer (IEND) chunk as a last chunk of the critical chunks, and positioning ancillary chunks at a tail of the packet after the IEND chunk.

3. The method of claim 1, wherein positioning the chunks comprises positioning all critical chunks of a layer before all ancillary chunks of the layer.

4. The method of claim 1, wherein positioning the chunks comprises positioning a critical chunk of a lower priority layer before an ancillary chunk of a higher priority layer.

5. The method of claim 1, further comprising receiving, by a receiver of the image source, a request for the interlaced image file containing parameters, and wherein positioning the chunks in the packet in a priority order of the priority is based on the parameters in the request.

6. The method of claim 5, wherein the parameters in the request indicate one or more of:
an image smoothness requirement of an image destination, an image attribute preference of the image destination, or a decoding capability of the image destination.

7. The method of claim 1, wherein the chunks are positioned to support removal of ancillary chunks by a packet wash process during packet transit.

8. The method of claim 3, further comprising:
assigning, by the one or more processors, a layer priority level to each layer, wherein each successive layer receives a decreasing priority level;
ordering, by the one or more processors, the chunks of each layer based on a layer priority level; and
positioning, by the one or more processors, the chunks of each layer prior to an IEND chunk or subsequent to the IEND chunk based on the layer priority level of the each layer.

9. The method of claim 8, wherein the IEND chunk indicates a threshold beyond which no packet wash can be applied when proceeding from a tail of the packet to a head of the packet.

10. A method implemented by a transit node, the method comprising:
receiving, by a receiver of the transit node, a packet containing data associated with an interlaced image file, the packet including chunks arranged in a priority order of priority with critical chunks positioned at a head of the packet, an image trailer (IEND) chunk positioned as a last critical chunk, and ancillary chunks positioned at a tail of the packet after the IEND chunk;
dropping, by one or more processors of the transit node, ancillary chunks from the packet as part of a packet wash until the packet is transmissible; and
transmitting, by a transmitter of the transit node, the packet toward an image destination.

11. The method of claim 10, wherein the ancillary chunks are dropped starting at the tail of the packet and progressing toward the head of the packet.

12. The method of claim 11, further comprising identifying ancillary chunks eligible for dropping based on a position of the IEND chunk.

13. The method of claim 10, wherein the interlaced image file includes a plurality of layers, and wherein at least one chunk in the packet contains image data of a layer that is designated as ancillary.

14. The method of claim 13, wherein the packet corresponds to a stream of packets associated with one layer of the interlaced image file.

15. The method of claim 14, wherein the packet is a jumbo packet that includes an entire interlaced image file.

16. The method of claim 15, wherein the IEND chunk indicates a threshold beyond which no packet wash can be applied when proceeding from the tail of the packet to the head of the packet.

17. The method of claim 16, wherein the IEND chunk is not positioned as a last chunk in the packet.

18. The method of claim 16, wherein a second IEND chunk is positioned as a last chunk in the packet.

19. An image source comprising:
a memory storing instructions; and
at least one processor in communication with the memory, the at least one processor configured, upon execution of the instructions, to perform the following steps:
designating each chunk of a plurality of chunks of an interlaced image file as critical or ancillary;
positioning the chunks in a packet in a priority order according to a priority of the chunks and their designation as critical or ancillary; and
transmitting the packet toward an image destination.

20. A transit node comprising:
a memory storing instructions; and
at least one processor in communication with the memory, the at least one processor configured, upon execution of the instructions, to perform the following steps:
receiving a packet containing data associated with an interlaced image file, the packet including chunks arranged in an order of priority with critical chunks positioned at a head of the packet, an image trailer (IEND) chunk positioned as a last critical chunk, and ancillary chunks positioned at a tail of the packet after the IEND chunk;
dropping ancillary chunks from the packet as part of a packet wash until the packet is transmissible; and
transmitting the packet toward an image destination.
